(19) United States
(12) Patent Application Publication
(10) Pub. No.: US 2003/0065957 A1
(43) Pub. Date: Apr. 3, 2003

(54) IC card that can have user restricted, authorized person determination method, authorized person determination program, descrambler, authorized person registration method, authorized person registration program, server device administering usage admitted count of IC card, count administration method, and physical description reader

(76) Inventors: Nobuhisa Tsuji, Osaka (JP); Masayuki Ehiro, Osaka (JP); Teruaki Morita, Kitakatsuragi-gun (JP)

Correspondence Address: BIRCH STEWART KOLASCH & BIRCH, PO BOX 747, FALLS CHURCH, VA, 22040-0747, US

(21) Appl. No.: 10/256,192

(22) Filed: Sep. 27, 2002

(30) Foreign Application Priority Data
Sep. 28, 2001 (JP) 2001-301249
May 17, 2002 (JP) 2002-143344

(51) Int. Cl. H04L 9/32; H04N 7/16

(52) U.S. Cl. 713/202; 725/30

(57) ABSTRACT

A pay television IC card includes a storage unit prestoring fingerprint information that allows identification of a registrant, a fingerprint information input unit accepting input of physical description data of a user, a comparison determination unit comparing fingerprint information accepted by the fingerprint information input unit with fingerprint information stored in the storage unit to determine whether the user is the registrant, and a descramble key generation unit providing a descramble key based on the determination result by the comparison determination unit. A descramble key is output by determining whether the user and the registrant are the same person based on fingerprint information, and determination of the sameness between the user and the registrant is established.

### BACKGROUND OF THE INVENTION

1. Field of the Invention

The present invention relates to an IC card, an authorized person determination method, an authorized person determination program, a computer readable recording medium recorded with an authorized person determination program, and a descrambler, that can have the user restricted. The present invention also relates to an authorized person registration method, an authorized person registration program, and a computer-readable recording medium recorded with an authorized person registration program that allows an authorized person to be registered. Furthermore, the present invention relates to a server device, an administration method, a computer-readable recording medium recorded with an administration program, and a physical description reader to administer the usage admitted count of an IC card.

2. Description of the Background Art

A satellite broadcast system transmitting pay television information through a satellite and having the pay television information received at a terrestrial television set is conventionally known. FIG. 24 is a schematic diagram of a conventional satellite broadcast system. Referring to FIG. 24, a broadcast station 305 scrambles television video and audio signals, and then sends the scrambled signals to a broadcast satellite 303. Broadcast satellite 303 transmits the received television video and audio signals to terrestrial reception systems 501A, 501B and 501C. Terrestrial reception systems 501A, 501B and 501C receive the scrambled television video and audio signals through broadcast satellite 303 through a receiver. The scramble is canceled to allow output of video, audio, and the like from the television set. The television video and audio signal are transmitted in a scrambled form in order to restrict the viewer of the pay television to only certain restricted contractants.

In a conventional satellite broadcast system, two operations modes are employed to restrict the person who can cancel the scramble to only the contractor. Regarding the first operation mode, a descrambler is incorporated in a receiver, which is acquired by the contractor. Regarding the second operation mode, a descrambler is provided with an IC card. The IC card thereof is issued for each contractor of the pay television.

Since the descrambler is provided for each receiver in the first operation mode, the contract for a subscriber of a pay television is concluded for each receiver. In contrast, an IC card will be issued for each subscriber of the pay television since an ID code is set for each IC card in the second operation mode. When the subscriber wishes to view the pay television, he/she inserts the issued IC card into the receiver to allow cancel of the scrambled television video and audio signals. Since the IC card is portable, the second operation mode is advantageous in that pay television can be viewed even when not at home by just inserting an IC card as long as there is a receiver at the destination. With respect to the second operation mode in which the IC card is sold to an indefinite number of persons, Japanese Patent Laying-Open No. 9-139930 discloses the approach to solve the complexity in administering the period of contract.

FIG. 25 is a diagram to describe the concept of a conventional satellite broadcast system. Referring to FIG. 25, pay television information including video and audio signals, a scramble key, attribute information of the program, a work key, and contract information is sent from the transmitter side to the receiver side. Upon receiving the pay television information at the receiver side, an ID number collation circuit 401 fetches the individual information matching the ID number stored in a read-only memory (ROM), and transmits the individual information to an encryption decoder 405. It is to be noted that a work key is included in the individual information. Encryption decoder 405 provides to an encryption decoder 407 a work key (Kw) obtained by decoding the received individual information using a master key (Km) prestored in the ROM. Encryption decoder 407 uses the work key (Kw) to decrypt the program information included in the pay television information to output a scramble key (Ks) and date data. The scramble key (Ks) is provided to a switch 405. Date data is provided to a determination circuit 409. An expiration date obtained from the valid term prestored in the ROM is recorded in determination circuit 409. Determination circuit 409 compares the expiration date prestored in the ROM with the date data received by encryption decoder 407. In the case where the expiration date has not yet come to an end, switch 505 is turned ON, whereby the scramble key (Ks) output from encryption decoder 407 can be input to a PN signal generator 402. A PN signal is a pseudo random signal.

PN signal generator 402 uses the received scramble key (Ks) to output a PN signal to a video audio descrambler 403. Video audio descrambler 403 cancels the scrambling of the video and audio signals included in the pay television information based on the received PN signal. As a result of descrambling the video and audio signals, the television video and audio can be output through a television set at the receiver side. The technique disclosed in Japanese Patent Laying-Open No. 9-139930 allows pay television to be viewed within a limited period of time through usage of an IC card.

Referring to FIG. 24 again, reception system 501A corresponds to the case where an IC card of a valid expiration date is inserted into the receiver. The scramble of the video and audio signals is canceled to allow output of video and audio signals at the television set. Reception system 501B corresponds to the case where an expired IC card is inserted into the receiver. The scrambling of the video and audio signals is not canceled, so that no video or audio is output from the television set. Reception system 501C corresponds to the case where an IC card is not inserted into the receiver. Likewise the case of reception system 501B, the scramble of the video and audio signals is not canceled, so that no video or audio is output from the television set.

In a pay television system employing a conventional IC card, an IC card is issued for each contractor of the pay television system. One card is required for one contractor. This means that a plurality of IC cards, corresponding in number to the members of a family, is required in one household. In view of a pay television program restricted to persons over a specified age, different IC cards must be issued, i.e., an IC card issued to those below a certain age, and an IC card issued to those over a specified age.

A conventional IC card can cancel the scramble as long as its ID code is stored in the ROM, and the ID code is a legitimate one. However such an ID code has been assigned only for the purpose of the pay television service provider to administer the contractor. The match between an IC card and user thereof cannot be established. It is not possible to confirm whether the user who has inserted the IC card into the receiver matches the person to whom the IC card has been issued to allow viewing of the pay television. For example, consider the case where an IC card is lost and passed to the hands of a stranger. There is a problem that the stranger with the IC card can view pay television programs by means of that IC card. Thus, the ID code recorded in a conventional IC card is envisaged only to determine whether a proper issued IC card based on a contract is used or not. No account is paid on the security when the IC card is lost.

An IC card has the capability to determine whether to cancel the scramble of an age-restricted program based on the ID code. This means that an ID code must be assigned to each user of different age. There is a problem that each person must posses his/her own IC card. Even in the case where an IC card is possessed by each individual, determination cannot be made whether the user of the IC card is actually the owner of the IC card. There is a problem that a person below a specified age may use an IC card owned by another person over a specified age without permission to cancel the scramble of an age-restricted program.

### SUMMARY OF THE INVENTION

In view of the foregoing, an object of the present invention is to provide an IC card that can easily restrict the usage to an intended end-user, an authorized person determination method, an authorized person determination program, and a computer readable recording medium recorded with an authorized person determination program.

Another object of the present invention is to provide an IC card that allows usage among a plurality of persons.

A further object of the present invention is to provide an IC card that can cancel scrambled age-restricted broadcasting information for only the usage to an end-user not subject to an age limit, an authorized person determination method, an authorized person determination program, and a computer-readable recording medium recorded with an authorized person determination program.

Still another object of the present invention is to provide an IC card that allows registration of only an authorized person, an authorized person registration method, an authorized person registration program, and a computer-readable recording medium recorded with an authorized registration program.

A still further object of the present invention is to provide a descrambler that can easily restrict the usage to an intended end-user.

Yet a further object of the present invention is to provide a server device that can administer the usage admitted count of an IC card securely and easily, a count administration method, a count administer program, and a computer-readable recording medium recorded with such a program.

Yet another object of the present invention is to provide a physical description reader to administer a user in correspondence with the usage admitted count of an IC card.

According to an aspect of the present invention, an IC card includes a physical description data storage unit for prestoring physical description data that allows identification of a predetermined person, a physical description data acceptance unit accepting input of physical description data of a user, a determination unit comparing physical description data accepted by the physical description data acceptance unit with physical description data stored in the physical description data storage unit to determine whether the user is the predetermined person, and an output unit providing an admission signal based on the determination result by the determination unit.

According to the invention of the present aspect, determination of whether the person using the IC card is the predetermined person whose physical description data is prestored can be easily made. Since an admission signal is output based on the determined result of the user being the predetermined person, an IC card is provided that can easily restrict the usage to an intended end-user.

According to an aspect of the present invention, an authorized person determination method includes the steps of prestoring physical description data that allows identification of a predetermined person, accepting input of physical description data of a user, comparing the physical description data accepted at the physical description data acceptance step with prestored physical description data to determine whether the user is the predetermined person, and providing an admission signal based on the determination result of the determination step.

According to the invention of the present aspect, determination can easily be made whether the user is a predetermined person whose physical description data is prestored. Since an admission signal is output based on the determined result of the user being the predetermined person, an authorized person determination method that can easily restrict the user to an intended end-user can be provided.

According to a further aspect of the present invention, an authorized person determination program causes a computer to execute the steps of prestoring physical description data that allows identification of a predetermined person, accepting input of physical description data of a user, comparing physical description data accepted at the physical description data acceptance step with prestored physical description data to determine whether the user is the predetermined person, and providing an admission signal based on the determination result of the determination step.

According to the invention of the present aspect, determination can easily be made whether the end-user is the predetermined person whose physical description data is prestored. Since an admission signal is output based on the determined result of the user being the predetermined person, an authorized person determination program that can easily restrict the usage to an intended end-user and a computer readable recording medium recorded with such an authorized person determination program can be provided.

According to still another aspect of the present invention, an IC card includes a storage unit storing physical description data that allows identification of a predetermined person, an acceptance unit accepting input of physical description data of a person, a determination unit comparing input physical description data with stored physical description data of the predetermined person to determine whether the person corresponding to the input physical description data is the predetermined person, and a control unit providing control so as to, when determination is made that the person corresponding to the input physical description data is the predetermined person by the determination unit, allow input of physical description data of another person differing from the predetermined person at the acceptance unit and store the input physical description data of the another person in the storage unit.

According to the invention of the present aspect, input of physical description data of another person is allowed on the condition that physical description data of a predetermined person is input. Therefore, an IC card that allows registration of only an authorized person can be provided.

According to a still further aspect of the present invention, an authorized person registration method includes the steps of storing physical description data that allows identification of a predetermined person, accepting input of physical description data of a person, comparing input physical description data with the stored physical description data of a predetermined person to determine whether the person corresponding to the input physical description data is a predetermined person, allowing input of physical description data of another person differing from the predetermined person when determination is made that the person corresponding to the input physical description data is the predetermined person at the determination step, and storing the input physical description data of the another person.

According to the invention of the present aspect, input of physical description data of another person is allowed on the condition that physical description data of a predetermined person is input. Therefore, an authorized person registration method that allows registration of only an authorized person can be provided.

According to yet a further aspect of the present invention, an authorized person registration program causes a computer to execute the steps of storing physical description data that allows identification of a predetermined person, accepting input of physical description data of a person, comparing input physical description data with stored physical description data of a predetermined person to determine whether the person corresponding to the input physical description data is the predetermined person, allowing input of physical description data of another person differing from the predetermined person when determination is made that the person corresponding to the input physical description data is the predetermined person at the determination step, and storing the input physical description data of the another person.

According to the invention of the present aspect, input of physical description data of another person is allowed on the condition that physical description data of a predetermined person is input. Therefore, an authorized person registration program that allows registration of only an authorized person and a computer readable recording medium recorded with such an authorized person registration program can be provided.

According to yet another aspect of the present invention, a descrambler includes a physical description data storage unit prestoring physical description data that allows identification of a predetermined person, a reader reading out physical description data of a user, a determination unit comparing physical description data read by the reader with physical description data stored in the physical description data storage unit to determine whether the user is a predetermined person, and a descramble unit canceling scramble of information subjected to scrambling based on the determination result by the determination unit.

According to the invention of the present aspect, the person using the descrambler can easily be identified since determination of the sameness between the predetermined person whose physical description data is prestored and the user is based on comparison of physical description data. Since a signal is output to cancel scramble of information subjected to scrambling is output based on the determined result of the user being the predetermined person, a descrambler that can easily restrict the usage to an intended end-user can be provided.

According to yet a further aspect of the present invention, a server device includes a usage admitted count storage unit storing a service number required to identify an IC card and a usage admitted count of the IC card in correspondence, a reception unit receiving physical description data to identify a person and a service number, and a control unit storing the received physical description data in correspondence with the received service number in the usage admitted count storage unit.

According to the invention of the present aspect, physical description data required to identify a person and a usage admitted count of an IC card are set in correspondence using a service number. Therefore, the usage admitted count of an IC card can be easily set in correspondence with each person. Furthermore, since the physical description data to identify a person and the IC card usage admitted count are set in correspondence, the correspondence can be maintained even in the case where the IC card is lost. Thus, a server device that can administer the usage admitted count of an IC card securely and easily can be provided.

According to an additional aspect of the present invention, a count administration method is executed by a server device including a usage admitted count storage unit storing the service number required to identify an IC card and the usage admitted count of an IC card in correspondence. The count administration method includes the steps of receiving physical description data required to identify a person and a service number, and storing the received physical description data in correspondence with the received service number in the usage admitted count storage unit.

According to the invention of the present aspect, a count administration method that can administer the usage admitted count of an IC card securely and easily can be provided.

According to still an additional aspect of the present invention, a count administration program is executed by a server device including a usage admitted count storage unit storing a service number required to identify an IC card and an IC card usage admitted count in correspondence. The count administration program includes the steps of receiving physical description data required to identify a person and a service number, and storing the received physical description data and the received service number in correspondence in the usage admitted count storage unit.

According to the invention of the present aspect, a count administration program that can administer the usage admitted count of an IC card securely and easily, and a computer-readable recording medium recorded with such a count administration program can be provided.

According to yet an additional aspect of the present invention, a physical description data reader includes a service number reception unit receiving a service number required to identify an IC card from an IC card, a physical description data reader unit reading out physical description data of a user, and a transmission unit transmitting the physical description data read out and the received service number to the server device storing the usage admitted count of an IC card.

According to the invention of the present aspect, a service number required to identify an IC card and the physical description data of a user are transmitted to the server device storing the IC card usage admitted count. Thus, a physical description data reader to administer the user and the IC card usage admitted count in correspondence can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a schematic structure of a pay television system according to a first embodiment of the present invention.

FIG. 2 is a block diagram of a schematic structure of a descramble module according to the first embodiment.

FIG. 3 is a block diagram of a schematic structure of an IC card for pay television of the first embodiment.

FIG. 4 shows an example of a registrant database stored in the storage unit of the pay television IC card of the first embodiment.

FIG. 5 shows a detailed structure of an information temporary storage unit and a comparison determination unit of the pay television IC card of the first embodiment.

FIG. 6 is a flow chart of the process executed by the pay television IC card of the first embodiment.

FIG. 7 is a flow chart of the process executed by the descramble module of the first embodiment.

FIG. 8 is a diagram to describe the concept of the pay television system of the first embodiment.

FIG. 9 is a block diagram of a schematic structure of a descrambler according to a second embodiment.

FIG. 10 is a flow chart of the process of a descramble process executed by the descrambler of the second embodiment.

FIG. 11 shows a schematic structure of a pay television system according to a third embodiment.

FIG. 12 is a block diagram of a schematic structure of a master registration device of the third embodiment.

FIG. 13 is a block diagram of a schematic structure of the descramble module of the third embodiment.

FIG. 14 is a block diagram of a detailed structure of a data output unit 230A of a descramble module 200A of the third embodiment.

FIG. 15 is a block diagram of a schematic structure of a pay television IC card of the third embodiment.

FIG. 16 is a diagram to describe information stored in the storage unit of the pay television IC card of the third embodiment.

FIG. 17 is a block diagram showing a schematic structure of a server device of the third embodiment.

FIG. 18 shows an example of user data stored in the user data administration unit of the server device of the third embodiment.

FIG. 19 is a block diagram showing a detailed structure of a comparison unit in the server device of the third embodiment.

FIGS. 20A and 20B are flow charts of the process executed when a pay television IC card is to be purchased in the pay television system of the third embodiment.

FIGS. 21, 22, 23A, and 23B are flow charts of the process executed when a pay television IC card is used in the pay television system of the third embodiment.

FIG. 24 schematically shows a conventional satellite broadcasting system.

FIG. 25 is a diagram to describe the concept of the conventional satellite broadcasting system.

### DESCRIPTION OF THE PREFERRED EMBODIMENTS

Embodiments of the present invention will be described hereinafter with reference to the drawings.

In the drawings, the same or corresponding elements are indicated by the same reference characters. Description in multiplicity will not be provided.

First Embodiment

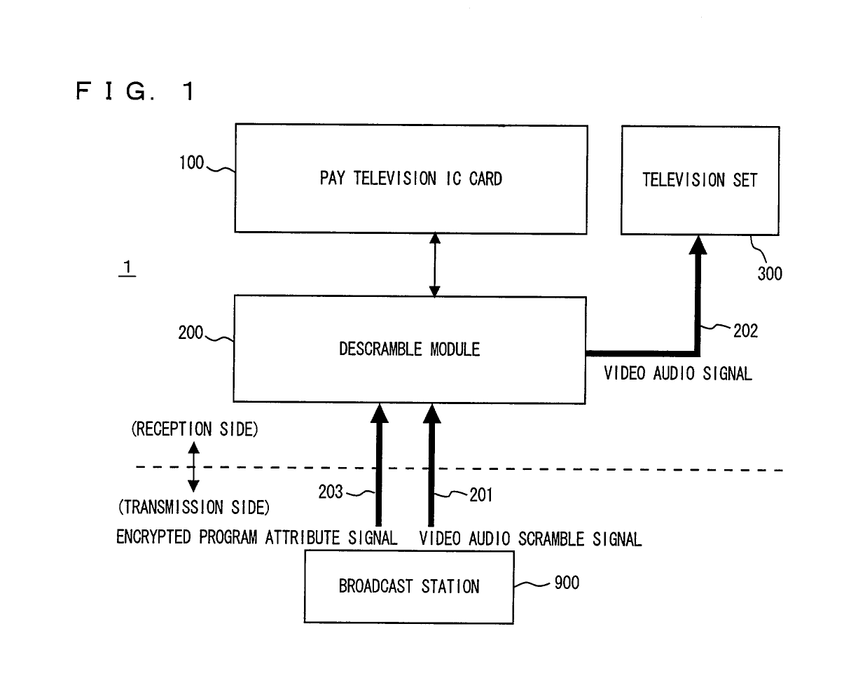

FIG. 1 shows a schematic structure of a pay television system according to a first embodiment of the present invention. A pay television system 1 is mainly divided into the transmission side and the reception side. The transmission side is configured with a broadcast station 900. The reception side is configured with a descramble module 200, an IC card 100 for pay television, and a television set 300.

At the transmission side, broadcast station 900 transmits an encrypted program attribute signal 203, and a video audio scramble signal 201. Either radio or cable can be employed for the transmission medium. In the case where the television program has an age limit prescribed, encrypted program attribute signal 203 includes program target age information indicating the specified age limit. Furthermore, information of a key to be used to cancel the scramble of a video audio scramble signal may be included.

Video audio scramble signal 201 is a signal of the video and audio subjected to scrambling for output to a television set 300 at the reception side. The video and audio cannot be output at television set 300 unless the scramble is canceled at the reception side.

Descramble module 200 at the reception side receives scrambled program attribute signal 203 and video audio scramble signal 201 transmitted from broadcast station 900. Descramble module 200 transmits the required information from the received program attribute signal 203 to pay television IC card 100.

Based on the information received by descramble module 200, pay television IC card 100 generates and transmits to descramble module 200 a descramble key to cancel the scramble of video audio scramble signal 201 for descramble module 200.

Pay television IC card 100 is readily detachable with respect to descramble module 200. Pay television IC card 100 has power supplied from descramble module 200 by being inserted into descramble module 200. Connection between pay television IC card 100 and descramble module 200 can be effected through a non-contact or contact type connection method.

Video audio signal 202 having the scramble canceled at descramble module 200 is output to television set 300. Upon receiving the video audio signal, television set 300 reproduces the video and audio. Thus, a viewer can enjoy the video and audio based on the video audio scramble signal 201 transmitted from broadcast station 900.

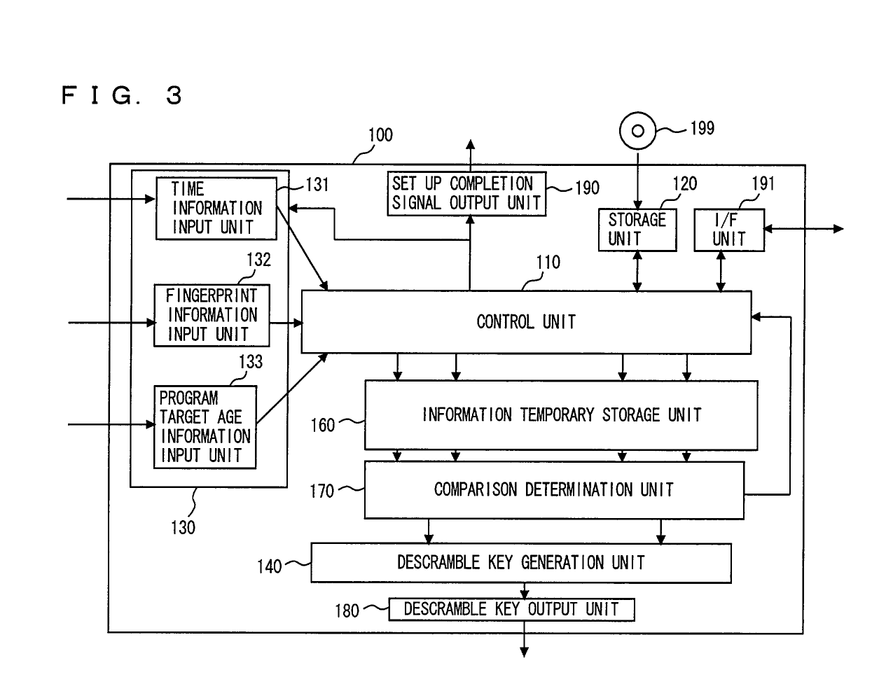

In order to watch a pay television program in pay television system 1 of the present embodiment, IC card 100 and descramble module 200 must be installed at the reception side. In the present embodiment, a pay television IC card 100 is acquired as set forth below. The person who wishes to watch a pay television program submits an application (referred to as “subscriber” hereinafter) in writing to the service provider of the pay television, or through a web site of the pay television service provider by means of the Internet. In the application for pay television broadcasting, the subscriber specifies his/her address, name, date of birth, a secret identification code determined by the subscriber, the method of payment, and the like. In response to such an application in writing or through the web site of the Internet, the pay television service provider writes in the date of birth information and secret identification code in correspondence with the service number of the subscriber using a contact type or non-contact type reader writer into a storage unit 120 (refer to FIG. 3) of pay television IC card 100 according to the contents of the application, and then delivers or hands over that pay television IC card to the subscriber.

Following acquirement of such a pay television IC card by the subscriber, the process set forth afterwards can be executed through pay television IC card 100 by inserting IC card 100 into a preinstalled descramble module 200.

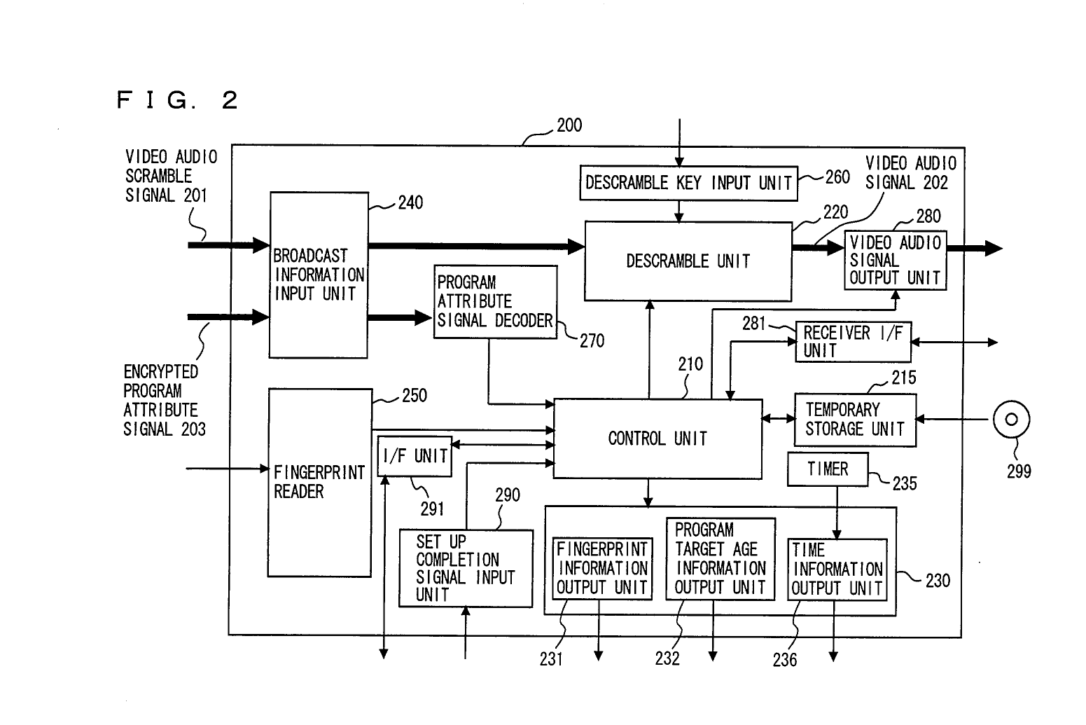

FIG. 2 is a block diagram showing a schematic structure of descramble module 200 of the first embodiment. Referring to FIG. 2, descramble module 200 includes a control unit 210 controlling the entirety of descramble module 200, a temporary storage unit 215 used as a work area when a program or the like is executed at control unit 210, a broadcast information input unit 240 receiving video audio scramble signal 201 and encrypted program attribute signal 203 transmitted from a broadcast station, a program attribute signal decoder 270 to decode encrypted program attribute signal 203, a descramble unit 220 to cancel scramble of video audio scramble signal 201, a descramble key input unit 260 receiving a descramble key from pay television IC card 100, a video audio signal output unit 280 providing video audio scramble signal 202 output from descramble unit 220 to television set 300, an interface (I/F) unit 281 for the receiver to transfer information with respect to television set 300, a fingerprint reader 250 to read out a fingerprint of a user, an interface unit (referred to as “I/F unit” hereinafter) 291 to transfer required information with respect to pay television IC card 100, a set up completion signal input unit 290 to receive a set up completion signal, and a data output unit 230 to provide fingerprint information, program target age information, and time information to pay television IC card 100.

Broadcast information input unit 240 receives encrypted program attribute signal 203 and video audio scramble signal 201 output from broadcast station 900. Broadcast information input unit 240 provides the encrypted program attribute signal 203 to program attribute signal decoder 270 and video audio scramble signal 201 to descramble unit 220.

Program attribute signal decoder unit 270 decodes encrypted program attribute signal 203 received from broadcast information input unit 240 and provides the program attribute signal to control unit 210.

Video audio scramble signal 201 is a signal having the video and audio scrambled. The video audio scramble signal is transmitted on a program-by-program basis. Information related to this program is the program attribute, included in the program attribute signal. When the audience of that program is restricted in age, program target age information indicating the age limit is included in the program attribute signal. The program target age information in the program attribute signal is output to pay television IC card 100 by program target age information output unit 232 of data output unit 230 that will be described afterwards.

Descramble unit 220 cancels the scramble of video audio scramble signal 201 received by broadcast information input unit 240. The descramble key required in canceling the scramble is received from descramble key input unit 260. Therefore, descramble unit 220 cannot cancel the scramble of video audio scramble signal 201 unless a descramble key is received from descramble key input 260. In other words, the scramble of video audio scramble signal 201 is canceled to allow video audio signal 202 to be provided to video audio signal output unit 280 only when a descramble key is received by descramble key input unit 260.

Fingerprint reader 250 includes a charge coupled device (CCD) to pick up an image of a fingerprint of the user of descramble module 200 to convert the image into electrical image data, which is output to control unit 210. Data of the picked up image of a fingerprint output from fingerprint reader 250 is referred to as fingerprint information hereinafter. Fingerprint information is temporarily stored in a temporary storage unit 215 to be read out in response to input of a set up completion signal by set up completion signal input unit 290. The fingerprint information read out is output to pay television IC card 100 by fingerprint information output unit 231.

Descramble key input unit 260 receives a descramble key from pay television IC card 100, and provides the received descramble key to descramble unit 220. Descramble key input unit 260 provides the descramble key to descramble unit 220 during the reception of a descramble key from pay television IC card 100.

An I/F unit 291 is connected to an I/F unit 191 of pay television IC card 100 to allow input/output of predetermined information to/from pay television IC card 100.

Set up completion signal input unit 290 receives and provides to control unit 210 a set up completion signal output from a set up completion signal output unit 190 of pay television IC card 100. The set up completion signal indicates that pay television IC card 100 is connected to descramble module 200 and is operable. Control unit 210 can determine that pay television IC card 100 is inserted in descramble module 200 for the duration of receiving a set up completion signal by set up completion signal input unit 290.

A timer 235 takes count of the current date and time. The output of timer 235 is provided to a time information output unit 236 as the date and time information. The date and time information is provided from time information output unit 236 to pay television IC card 100.

Data output unit 230 includes fingerprint information output unit 231, program target age information output unit 232, and time information output unit 236. Fingerprint information output unit 231 provides fingerprint information stored in temporary storage unit 215 to pay television IC card 100. Program target age information output unit 232 provides program target age information from the program attribute signal decoded by program attribute signal decoder 270 to pay television IC card 100. Time information output unit 236 provides the current date counted by timer 235 to pay television IC card 100.

Receiver I/F unit 281 receives numerical information input through a numeric input unit provided at television set 300. The input numeric information is provided to control unit 210. The numeric input unit provided at television set 300 may be an input button or remote controller provided at television set 300. The input numeric information includes a secret identification number and the date of birth that will be described afterwards. In order to prompt a user to input numeric information, a screen that prompts input can be provided at television set 300 by video audio signal output unit 280.

A recording medium 299 has a program to be executed at control unit 210 recorded. Descramble module 200 reads out the program recorded in recording medium 299 to execute a process according to the program read out.

FIG. 3 is a block diagram of a schematic structure of pay television IC card 100 of the first embodiment. Referring to FIG. 3, pay television IC card 100 includes a control unit 110 to control the entirety of pay television IC card 100, a storage unit 120 to store information related to a registrant, a data input unit 130 to receive required information from descramble module 200, a set up completion signal output unit 190 to output a set up completion signal when connection with a descramble module 200 is established, an information temporary storage unit 160, a comparison determination unit 170 performing a comparison determination process using information stored in information temporary storage unit 160, a descramble key generation unit 140 to generate a descramble key based on the comparison determination result from comparison determination unit 170, a descramble key output unit 180 to provide the generated descramble key to descramble module 200, and an interface unit 191 connected to I/F unit 291 of descramble module 200 to input/output the required information (referred to as I/F 191 hereinafter).

When the power on and reset operation of pay television IC card 100 is completed, set up completion signal output unit 190 issues a set up completion signal to set up completion signal input unit 290 of descramble module 200. When a user of pay television IC card 100 inserts pay television IC card 100 into descramble module 200 after television set 300 and descramble module 200 are turned ON, power is supplied from descramble module 200 to pay television IC card 100. Pay television IC card 100 provided with power is turned ON, and a reset operation is initiated. This reset operation is under control of control unit 110. When the power on and reset operation of pay television IC card 100 is completed under control of control unit 110, a set up completion signal is output from set up completion signal output unit 190 to set up completion signal input unit 290.

Data input unit 130 includes a time information input unit 131, fingerprint information input unit 132, and a program target age information input unit 133. When pay television IC card 100 is inserted into descramble module 200, time information input unit 131 is connected to time information output unit 236 of descramble module 200 to receive the current date and time that is counted by timer 235 from time information output unit 236. The received date and time information is output to control unit 110.

When pay television IC card 100 is inserted into disclosure module 200, fingerprint information input unit 132 is connected to fingerprint information output unit 231 of descramble module 200. Fingerprint information is received from fingerprint information output unit 231 and provided to control unit 110.

When pay television IC card 100 is inserted into descramble module 200, program target age information input unit 133 is connected to program target age information output unit 232 of descramble module 200. Program target age information is received from program target age information output unit 232 of descramble module 200 to be provided to control unit 110.

Storage unit 120 includes a registrant database to register a person who is admitted as an audience of pay television as a registrant. In the registrant database are stored a service number assigned for each registrant, fingerprint information of that registrant, date of birth information, and actual age information in correspondence. The service number is determined arbitrarily by control unit 110. Fingerprint information received through fingerprint information input unit 132 is stored as fingerprint information in the registrant database. Date of birth information stored in the registrant database is received from I/F unit 191. The actual age information stored in the registrant database is obtained by the information based on the date of birth and the current date received through time information input unit 131. The flow of a registrant database generation process will be described in detail afterwards.

A secret identification code unique to pay television IC card 100 is stored in the registrant database in storage unit 120. This secret identification code is recorded into storage unit 120 when a pay television IC card 100 is issued from a broadcast service provider such as broadcast station 900.

Preferably, a memory that cannot be rewritten once information is stored is used for storage unit 120. This preferably includes a memory that requires a rewrite admission signal for rewriting, a fuse type memory, or the like.

Information temporary storage unit 160 is a random access memory, temporarily storing fingerprint information of a user received at fingerprint information input unit 132, fingerprint information of a registrant stored in storage unit 120, program target age information received at program target age information input unit 133 , and the actual age of the registrant stored in storage unit 120.

Comparison determination unit 170 compares fingerprint information obtained by reading out a fingerprint of a user with the fingerprint information of a registrant stored in storage unit 120 to identify whether the user and the registrant are the same person. When program target age information is stored in information temporary storage unit 160, comparison determination unit 170 compares the program target age information with the actual age of the registrant stored in storage unit 120. Comparison determination unit 170 outputs an admission signal to descramble key generation unit 140 when determination is made of the sameness between the user and the registrant, or in the case where program target age information is stored in information temporary storage unit 160, when determination is made that the user is the same person as the registrant and the actual age is equal to or higher than the value of the program target age information.

Descramble key generation unit 140 generates and provides to descramble key output unit 180 a descramble key on the condition that an admission signal is received from comparison determination unit 170. In the case where key information to generate a descramble key is transmitted from a transmission station, the transmitted key information is received to generate a descramble key based on the received key information.

Descramble key output unit 180 provides the received descramble key to descramble key input unit 260 of descramble module 200.

Recording medium 199 is recorded with the program executed by control unit 110. Pay television IC card 100 reads out the program recorded in recording medium 199 to execute a process according to the program read out.

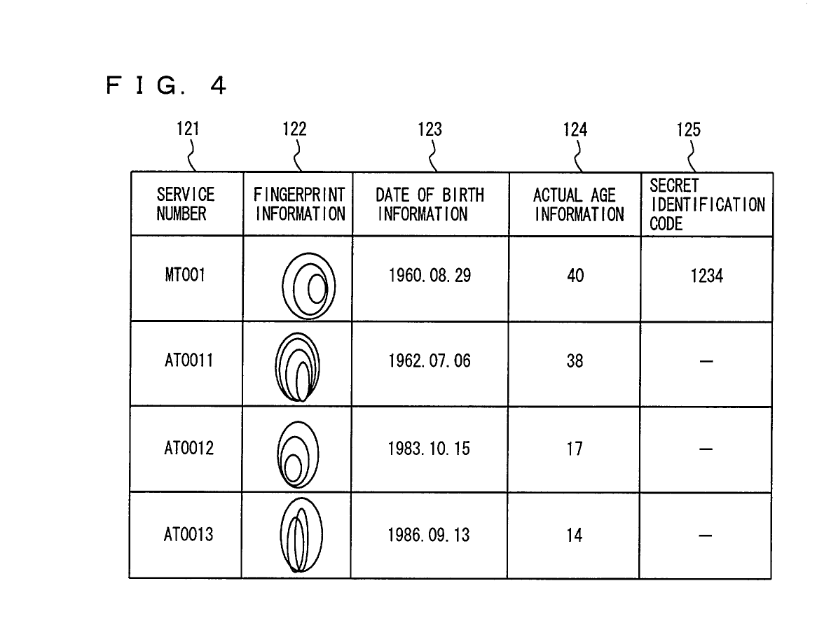

FIG. 4 shows an example of a registrant database stored in storage unit 120 of pay television IC card 100 of the first embodiment. Referring to FIG. 4, the registrant database is stored with a service number 121, fingerprint information 122, birth of date information 123, actual age information 124, and a secret identification code 125 for each registrant. Service number 121 is assigned by control unit 110 of pay television IC card 100 for each registrant. Service number 121 differs for each recorded registrant.

Fingerprint information 122 corresponds to a registrant. This fingerprint information is obtained by reading out the fingerprint of a registrant through fingerprint reader 250 of descramble module 200 in the registration process that will be described afterwards. Date of birth information 123 is the date of birth of a registrant, input through a remote controller or the like of television set 300 by a registration process that will be described afterwards. Date of birth information 123 is received at receiver I/F unit 281 for storage. Actual age information 124 is calculated by control unit 110 for storage. At control unit 110, the actual age of a registrant is calculated based on the current date received through time information input unit 131 and date of birth information 123 in the registrant database. The calculated actual age is stored in actual age information 124 of the registrant database. Calculation of actual age information by control unit 110 may be conducted every time power is supplied to pay television IC card 100, or at a predetermined interval, for example, every day.

Secret identification code 125 is a unique number of 4 digits of pay television IC card 100. The number of digits of the secret identification code is not limited to 4. This secret identification code 125 is stored in storage unit 120 by a pay television service provider when pay television IC card 100 is issued.

The subscriber that has applied for watching the pay television will become the only person that can use the IC card for pay television broadcasting. This is because only the subscriber is aware of the secret identification code. The subscriber who is aware of the secret identification code 125 can store his/her fingerprint information into the registrant database in storage unit 120 using secret identification code 125. Therefore, at least one secret identification code 125 should be present in pay television IC card 100. The subscriber that is first registered is called the master registrant. According to secret identification code 125, fingerprint information of the master registrant can be input on the condition that the secret identification code is input in the registration process that will be described afterwards. It is to be noted that the secret identification code can be deleted from pay television IC card 100 after the fingerprint information of the master registrant is input.

Furthermore, the date of birth information of only the master registrant is stored in storage unit 120 by the pay television service provider when the pay television IC card 100 is issued.

FIG. 4 corresponds to the case where four registrants are recorded in the registrant database. The registrant whose service number is MT001 is the master registrant. The data of the master registrant includes a secret identification code in addition to the fingerprint information, date of birth information, and actual age information. The registrants whose service numbers are AT0011, AT0012 and AT0013 are additional registrants. The data corresponding to the additional registrant includes a service number, fingerprint information, date of birth information, and actual age information. The additional registrant data does not include a secret identification code.

FIG. 4 corresponds to the case where the data of three additional registrants is stored in addition to the data of the master registrant in the registrant database. However, the registrant database does not necessarily have to store data of an additional registrant. At least the data of the master registrant should be stored in the registrant database.

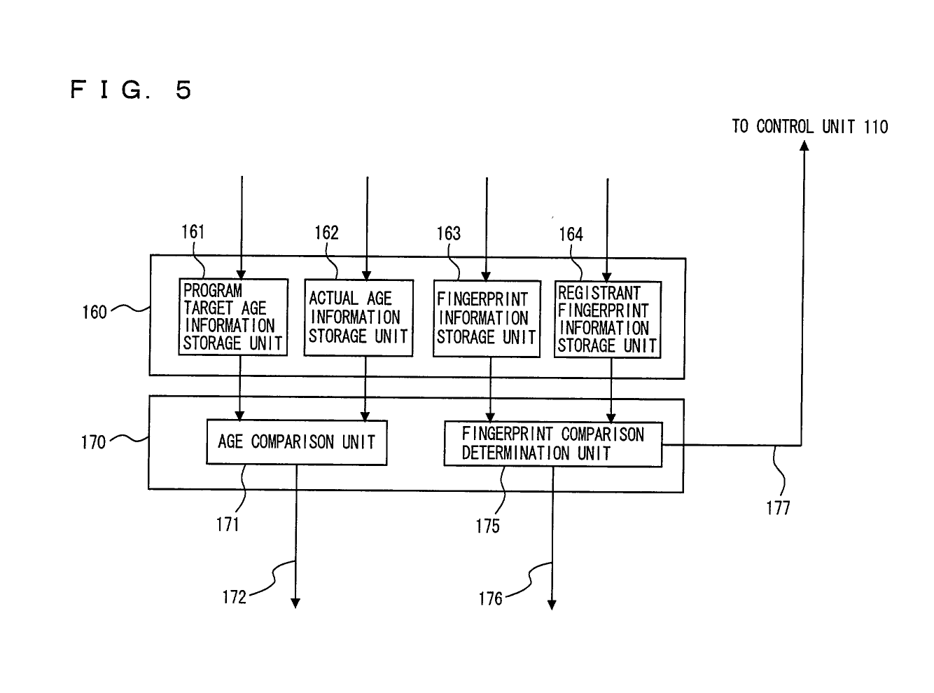

FIG. 5 shows the detailed structure of information temporary storage unit 160 and comparison determination unit 170 of pay television IC card 100 of the first embodiment. Referring to FIG. 5, information temporary storage unit 160 includes a program target age information storage unit 161 to temporarily store program target age information received at program target age information input unit 133, an actual age information storage unit 162 to temporarily store actual age information of a user read out from storage unit 120, fingerprint information storage unit 163 to temporarily store fingerprint information received at fingerprint information input unit 132, and a registrant fingerprint information storage unit 164 temporarily storing fingerprint information of a registrant stored in storage unit 120.

When there are a plurality of registrants stored in storage unit 120, the fingerprint information of a registrant is sequentially output from storage unit 120 into registrant fingerprint information storage unit 164. Fingerprint information received through fingerprint information input unit 132 is stored in fingerprint information storage unit 163. The fingerprint information received through fingerprint information input unit 132 is the fingerprint information of the fingerprint of a user read out and output by fingerprint reader 250 of descramble module 200.

Program target age information received through program target age information input unit 133 is stored in program target age information storage unit 161. The actual age information of a registrant corresponding to this fingerprint information stored in registrant fingerprint information storage unit 164 is stored in actual age information storage unit 162.

Comparison determination unit 170 compares the fingerprint information stored in fingerprint information storage unit 163 with fingerprint information stored in registrant fingerprint information storage unit 164 to determine whether fingerprint information matches or is similar to each other. In other words, determination is made whether the user of descramble module 200 is the same person as the registrant whose data is registered in storage unit 120 of pay television IC card 100. In the case where the fingerprint information stored in fingerprint information storage unit 163 matches or is similar to the fingerprint information stored in registrant fingerprint information storage unit 164 based on the comparison by fingerprint comparison determination unit 175, an admission signal 176 is output to descramble key generation unit 140. When the fingerprint information do not match, a signal 177 indicating mismatch is output to control unit 110.

Age comparison unit 171 compares the program target age information stored in program target age information storage unit 161 with the actual age information stored in actual age information storage unit 162 to output a signal 172 indicating the comparison result to descramble key generation unit 140. Signal 172 indicating the comparison result includes an admission signal output when the actual age included in the actual age information is equal to or above the program target age included in the program target age information, and a disallow signal that is output otherwise.

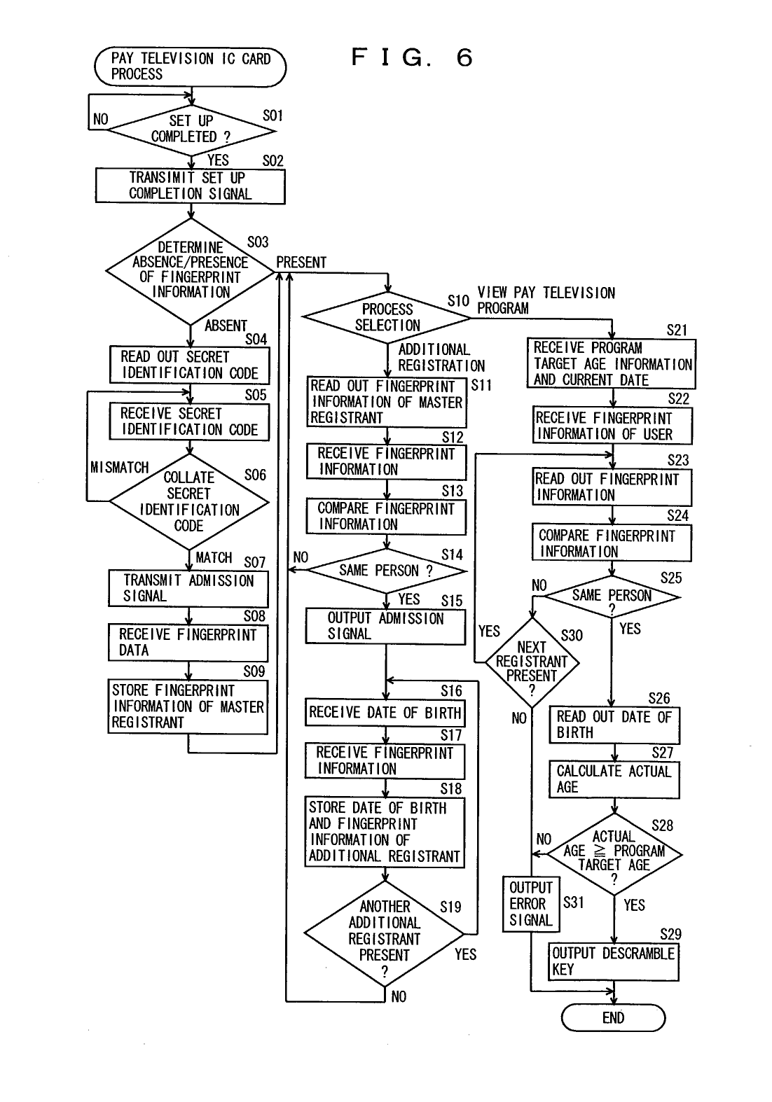

The process carried out at pay television IC card 100 will be described hereinafter with reference to the flow chart of FIG. 6 indicating the process executed at pay television IC card 100 in the first embodiment. In response to a user inserting pay television IC card 100 into the descramble module 200, power is supplied from descramble module 200 to pay television IC card 100. Pay television IC card 100 is turned ON to initiate a reset operation. This reset operation is under control of control unit 110. Determination is made whether the power on and reset operation of pay television IC card 100 is completed or not by control unit 110 (step S01). When determination is made of completion, a set up completion signal is continuously output from set up completion signal output unit 190 to set up completion signal input unit 290 (S02). When determination is made that the operation has not been completed, pay television IC card 100 attains a standby state until the power and reset operation is completed.

During reception of a set up completion signal, set up completion signal input unit 290 of descramble module 200 outputs a signal indicating an active state to control unit 210. When a set up completion signal is not received, a signal indicating an inactive state is output. Therefore, detection can be made of pay television IC card 100 being set during the reception of this set up completion signal at descramble module 200.

In an inactive state, data output unit 230 of descramble module 200 attains an inactive state. When power is not supplied from descramble module 200, pay television IC card 100 attains an inactive state. Also, data input unit 130 attains an inactive state. This means that, even if an externally applied signal is input to data input unit 130, control unit 110 will not conduct an operation to receive any of the input information. Furthermore, data output unit 230 of descramble module 200 does not conduct an operation to output any information in an inactive state.

Pay television IC card 100 attains an active state at the point of time when a set up completion signal is output from set up completion signal output unit 190, and remains at an inactive state at the stage prior to output of a set up completion signal. Whatever information is input to data input unit 130, control unit 110 will not conduct an operation to receive any input information when pay television IC card 100 is an inactive state. Control unit 110 accepts the information input to data input unit 130 only after a set up completion signal is output from set up completion signal output unit 190.

Similarly, information from data output unit 230 can be output only after a set up completion signal is input to set up completion signal input unit 290 and a signal indicating an active state is provided to control unit 210 at descramble module 200. Data output unit 230 can output no information during the period of time a signal indicating an inactive state is output from set up completion signal input unit 290 to control unit 210.

Thus, pay television IC card 100 and descramble module 200 attain an active state only after a set up completion signal is output from set up completion signal output unit 190 of pay television IC card 100. Accordingly, information can be transferred between pay television IC card 100 and descramble module 200.

Then, determination is made whether fingerprint information is present in the registrant database in storage unit 120 of pay television IC card 100 (step S03). When there is at least one fingerprint information, control proceeds to step S10, otherwise, to step (S04).

At step S04, a secret identification code prestored in the registrant database of storage unit 120 is read out. Control unit 110 outputs a command from I/F unit 191 to descramble module 200 indicating output of a screen prompting input of a secret identification code at television set 300.

Control unit 210 of descramble module 200 receives this command via I/F unit 291, whereby a screen indicating a message of, “Please enter application secret identification code”, for example, is provided on the display of television set 300 via video audio signal output unit 280. The user is made aware of the need to enter the secret identification code specified at the time of application by viewing the message displayed at television set 300. Therefore, a secret identification code is input through a numeric input unit such as a remote controller provided at television set 300.

The secret identification code input at television set 300 is received at control unit 210 of descramble module 200 via receiver I/F unit 281. The secret identification code received at descramble module 200 is transmitted to pay television IC card 100 via I/F 291.

At pay television IC card 100, I/F unit 191 receives the secret identification code from descramble module 200 (step S05).

Then, the secret identification code read out at step S04 is collated with the secret identification code received at step S05 (step S06). When the numbers match, control proceeds to step S07, otherwise, to step S05. At step S05 corresponding to a mismatch, a command that displays a screen indicating a message of “Please enter the secret identification code” on the display of television set 300 again is transmitted to descramble module 200.

In the case where the secret identification codes match as a result of collation, the user is recognized to be the subscriber since the user has knowledge of the secret identification code. Upon confirmation of the user being the subscriber, an admission signal is dispatched to descramble module 200 via I/F unit 191 at step S07.

At descramble module 200, the admission signal is received at I/F unit 291 and transmitted to control unit 210. In response to the received admission signal, control unit 210 of descramble module 200 transmits a command to display a screen with the message of “Please register the fingerprint of subscriber” at television receiver 300 from video audio signal output unit 280. In response, the screen is displayed at television set 300. Accordingly, the user can have his/her fingerprint read out by fingerprint reader 250 of descramble module 200.

Fingerprint reader 250 picks up an image of the fingerprint of the user. The image of the fingerprint is converted into electric signals by the CCD to be provided to control unit 210 as fingerprint information. Control unit 210 transmits the received fingerprint information to pay television IC card 100 via fingerprint information output unit 231. At pay television IC card 100, the fingerprint information is received at fingerprint information input unit 132 (step S08). The received fingerprint information is stored in the registrant database of storage unit 120 as the fingerprint information of the master registrant (step S09).

Following step S09, or when determination is made that there is fingerprint information at step S03, determination is made at pay television IC card 100 whether the user has selected an additional registration process for “REGISTRATION OF NEW USER”, or a pay television view process for “VIEW PAY TELEVISION PROGRAM” based on the signal received from descramble module 200 (step S10). In the case where an additional registration process is selected, control proceeds to step S11, otherwise, to step S21.

In this case, control unit 210 of descramble module 200 provides a screen including the two messages of “REGISTRATION OF NEW USER” and “VIEW PAY TELEVISION PROGRAM” to television set 300 from video audio signal output unit 280. The user enters a numeric value to select either process through a numeric input unit such as the remote controller. Descramble module 200 outputs a signal indicating which process has been selected to pay television IC card 100 based on the received numeric value.

At step S11, the fingerprint information of the master registrant previously registered is read out from the registrant database of storage unit 120. In the case where an additional registration process is selected, descramble module 200 provides a screen displaying a message of, for example, “Please enter fingerprint of master registrant” to television set 300 via video audio signal output unit 280. The user will have the fingerprint information read out by fingerprint reader 250 of descramble module 200 according to the message displayed at television set 300. An image of the fingerprint of the user is picked up by fingerprint reader 250 of descramble module 200. The fingerprint information is output to control unit 210. Control unit 210 provides the received fingerprint information to pay television IC card 100 via fingerprint information output unit 231. At pay television IC card 100, fingerprint information is received at fingerprint information input unit 132 to be output to control unit 110 (step S12).

Control unit 110 compares the fingerprint information received at step S12 with the fingerprint information of the master registrant read out at step S11 (step S13). Determination is made whether the master registrant in the registrant database of storage unit 120 is the same person as the user of descramble module 200 (step S14). Determination of the same person is made when the fingerprint information of the master registrant read out at step S11 is identical or similar to the fingerprint information of the user received at step S12. The fingerprint information is image data obtained by picking up an image of a fingerprint through an image sensing element such as a CCD. By subjecting the image data to pattern comparison, determination can be made whether the fingerprint information is identical or similar.

When determination is made of the same person at step S14, control proceeds to step S15, otherwise, to step S10. In order to register an additional registrant at step S15, an admission signal to permit additional registration is output to descramble module 200 via I/F unit 191.

Upon reception of an admission signal at descramble module 200 via I/F unit 291, control unit 210 outputs a screen displaying a message prompting entry of the date of birth and fingerprint of the additional registrant from video audio signal output unit 280 to television set 300. The message prompting entry of the date of birth and fingerprint information includes, for example, “Please enter the date of birth” and “Please enter fingerprint”.

Thus, the messages of “Please enter date of birth” and “Please enter fingerprint” are displayed at television set 300. As a result of the user entering the date of birth of the additional registrant through the numeric input unit of television set 300 such as the remote controller, the date of birth is received at control unit 210 via receiver I/F unit 281. Also, by having the fingerprint of the additional registrant read out by fingerprint reader 250, the read fingerprint information is transmitted to control unit 210. Upon receiving the date of birth, control unit 210 outputs the date of birth to pay television IC card 100 via I/F 291. Also, upon reception of fingerprint information, control unit 210 outputs the fingerprint information to pay television IC card 100 via fingerprint information output unit 231. At pay television IC card 100, the date of birth is received via I/F unit 191 (step S16). The fingerprint information is received via fingerprint information input unit 132 (step S17).

Thus, the received date of birth and fingerprint information of the additional registrant are newly stored into the registrant database of storage unit 120 (step S18).

At descramble module 200, a screen including a message of, for example, “Is there another registrant?” is output to television set 300 via video audio signal output unit 280. In response to this displayed message, the user enters numeric data indicating the presence/absence of another registrant through a numeric input unit such as the remote controller at television set 300. Then, the signal indicating the absence/presence of an additional registrant is received at control unit 210 via receiver I/F unit 281. Control unit 210 outputs the signal indicating the presence/absence of an additional registrant to pay television IC card 100 via I/F 291. At pay television IC card 100, determination is made whether there is another registrant based on the signal received via I/F unit 191 (step S19). When there is an additional registrant, control proceeds to step S16, otherwise, to step S10. The process of the above-described steps S16-S18 is repeated for each another additional registrant.

Thus, data registration of a registrant other than the master registrant is stored in the registrant data base of storage unit 120.

In the case where a pay television broadcast view process is selected at step S10, descramble module 200 outputs the current date, program target age information, and fingerprint data of the user. In response, the current date is received at time information input unit 131 to be stored in information temporary storage unit 160, and the program target age information is received at program target age information input unit 131 to be stored in program target age information storage unit 161 of information temporary storage unit 160 at pay television IC card 100 (step S21). Also, fingerprint data of the user is received at fingerprint information input unit 132 to be stored in fingerprint information storage unit 163 in information temporary storage unit 160 (step S22).

The fingerprint information recorded in the registrant database in storage unit 120 is sequentially read out and stored in registrant fingerprint information storage unit 164 of information temporary storage unit 160 (step S23).

Then, the fingerprint information of the user stored in fingerprint information storage unit 163 in step S22 is compared with the fingerprint information of the registrant stored in registrant fingerprint information storage unit 164 read out at step S23 (step S24). Determination is made whether the user is the same person as the registrant based on the comparison (step S25). When determination is made of the same person, control proceeds to step S26, otherwise, to step S30.

At step S26, the date of birth of the registrant corresponding to the fingerprint information stored in registrant fingerprint information storage unit 164 read out at step S23 is read out from the registrant database in storage unit 120. Based on the current date received at step S21 and the date of birth read out at step S26, the actual age which is the current age of the registrant is calculated and stored in actual age information storage unit 162 of information temporary storage unit 160 (step S27). In the case where the actual age information is stored in the registrant database of storage unit 120, the actual age information is read out from storage unit 120. In this case, steps S26 and S27 are not required.

Determination is made whether the actual age stored in actual age information storage unit 162 is equal to or above the program target age in the program target age information stored in program target age information storage unit 161 (step S28). When the actual age is equal to or above the program target age, control proceeds to step S29, otherwise, to step S31.

At step S29, a descramble key is generated at descramble key generation unit 140. The generated descramble key is output to descramble module 200 from descramble key output unit 180 (step S29).

When determination is made that the user is not the same person at step S25, determination is made whether a next registrant is registered in the registrant database in storage unit 120. When there is another registrant, control proceeds to step S23, otherwise, to step S31.

At step S31, an error signal is output from descramble key output unit 180.

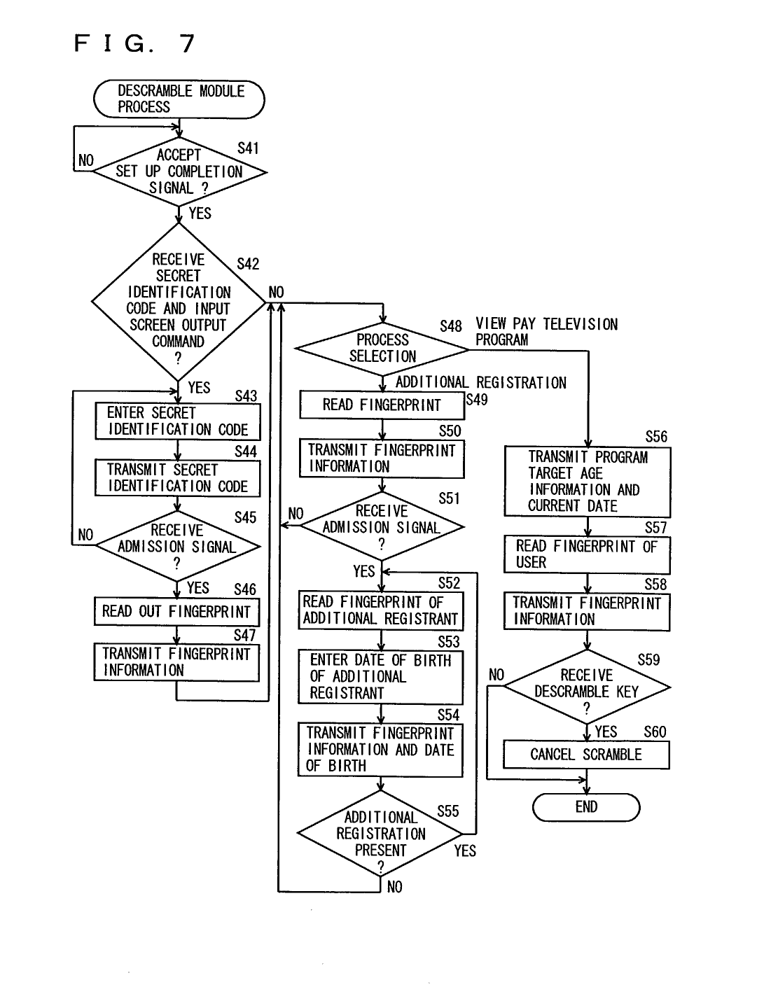

FIG. 7 is a flow chart of the process executed by descramble module 200 of the first embodiment. Referring to FIG. 7, descramble module 200 determines whether a set up completion signal has been received at set up completion signal input unit 260 from pay television IC card 100 (step S41). When a set up completion signal is received, control proceeds to step S42, otherwise, waiting is conducted. Thus, descramble module 200 attains an active state only when a set up completion signal is received, and otherwise attains an inactive state.

At step S42, determination is made whether a command has been received to output a screen prompting input of a secret identification code by pay television IC card 100. When the command has been received, control proceeds to step S43, otherwise, to step S48. At step S43, a screen including the message prompting input of a secret identification code, for example, “Please enter the secret identification code” is output to television set 300 from video audio signal output unit 280.

Upon input of a secret identification code by the user through a numeric value input unit such as a remote controller at television set 300, the input secret identification code is received at receiver I/F unit 281 (step S43). At control unit 210, the received secret identification code is transmitted to pay television IC card 100 via I/F unit 291 (step S44).

At pay television IC card 100, the determination is made whether the received secret identification code matches the secret identification code stored in the registrant database in storage unit 120. An admission signal is dispatched to descramble module 200 only when the secret identification codes match. At descramble module 200, determination is made whether an admission signal is received from pay television IC card 100 (step S45). When the admission signal is received, control proceeds to step S46, otherwise, to step S43. In the case where an admission signal is not received, a screen prompting input of a secret identification code again is output to television set 300. Input of a secret identification code is to be conducted again.

At step S46, a screen including the message of, for example, “Please enter fingerprint” on the display of television set 300 is output via video audio signal output unit 280. In response to the message displayed at television set 300, the user enters his/her fingerprint through fingerprint reader 250. The fingerprint is read out and output to control unit 210 as fingerprint information in the form of electronic data (step S46).

The read fingerprint information is transmitted from fingerprint information output unit 231 to pay television IC card 100 (step S47). Upon reception of fingerprint information, pay television IC card 100 has the received fingerprint information stored in the registrant database in storage unit 120 as the fingerprint information of the master registrant.

Following step S47, or when a command to output a secret identification code input screen at step S42 is not received, determination is made whether an additional registration process of conducting registration of a new user or a pay television view process to view a pay television program has been selected (step S48). Specifically, a screen to select whether to execute an additional registration process or a pay television program view process is output to television set 300 via video audio signal output unit 280. Such a screen includes, for example, a screen displaying the two messages of, “VIEW PAY TELEVISION PROGRAM” and“REGISTRATION OF NEW USER”. The user selects one of the two processes using a numeric input unit such as a remote controller of television set 300. A signal indicating which process has been selected is received at receiver I/F unit 281. At control unit 210, determination is made whether an additional registration process or a pay television program view process has been selected based on the received signal. Also, a signal indicating which process has been selected is output to pay television IC card 100 from I/F unit 291.

When an additional registration process has been selected, control proceeds to step S49. When the other pay television program view process has been selected, control proceeds to step S56.

At step S49, a screen prompting entry of the fingerprint of the master registrant is output to television set 300 via video audio signal output unit 280. The fingerprint is read by fingerprint reader 250. The fingerprint information is output to control unit 210 (step S49).

At step S50, fingerprint information corresponding to the signal read out at step S49 is transmitted to pay television IC card 100 via fingerprint information output unit 231.

At pay television IC card 100, the received fingerprint information is compared with the fingerprint information of the master registrant stored in storage unit 120 to determine whether the user is the same person as the master registrant. When determination is made of the same person at pay television IC card 100, an admission signal is output to descramble module 200. At descramble module 200, the admission signal is received at I/F unit 291.

At step S51, determination is made whether an admission signal is received or not. When an admission signal is received, control proceeds to step S52, otherwise, to step S48.

At step S52, a screen prompting entry of the fingerprint of an additional registrant is output to television set 300 via video audio signal output unit 280. The fingerprint of the additional registrant is read by fingerprint reader 250. The obtained fingerprint information is output to control unit 210.

Then, a screen including a message to prompt input of the date of birth of the additional registrant is output to television set 300 via video audio signal output unit 280. The date of birth input through the numeric input unit such as the remote controller of television set 300 is received at receiver I/F unit 281 (step S53).

The date of birth received at step S53 and the fingerprint information read out at step S52 are transmitted to pay television IC card 100 (step S54). The fingerprint information is transmitted via fingerprint information output unit 231. The date of birth information is transmitted via I/F unit 291.

Then, a screen including a message asking whether there is an additional registrant is output to television set 300 via video audio signal output unit 280. The user specifies where there is an additional registrant through the numeric input unit such as the remote controller. This signal is received at receiver I/F unit 281, and output to pay television IC card 100 from I/F unit 292. Determination is made of the absence/presence of an additional registrant based on the received signal (step S55). When a signal indicating that there is an additional registrant is received, control proceeds to step S52, otherwise to step S48. When there is an additional registrant, the process from steps S52-S54 is repeated. The fingerprint information and date of birth of each additional registrant are transmitted to pay television IC card 100.

When a pay television program view process is selected at step S48, program target age information is transmitted from program target age information output unit 232 to pay television IC card 100, and time information including the current date and time counted by timer 235 is output to pay television IC card 100 from time information output unit 236, based on the program attribute signal decoded by program attribute signal decoder 270 (step S56).

Then, a screen including a message of, for example “Please enter fingerprint” is output to television set 300 via video audio signal output unit 280. The fingerprint of the user is read out by fingerprint reader 250 (step S57). Fingerprint information read out by fingerprint reader 250 of the fingerprint of the user is output to pay television IC card 100 via fingerprint information output unit 231 (step S58).

Upon receiving the fingerprint information of the user at pay television IC card 100, the fingerprint information of the user is compared with the fingerprint information stored in the registrant database in storage unit 120 to determine whether the user is the same person as the registrant. Also, when program target age information is stored in program target age information storage unit 161, determination is made whether the actual age of the user is at least the age in the program target age information. In the case where program target age information is stored in program target age information storage unit 161, a descramble key is output to descramble module 200 when determination is made that the user is identical to the registrant, and the user's actual age is equal to or above the program target age. In the case where the program target age information is not stored in program target age information storage unit 161, the descramble key is output to descramble module 200 when determination is made that the user is the same person as the registrant.

At descramble module 200, determination is made whether a descramble key has been received at descramble key input unit 260 (step S59). When a descramble key has been received, control proceeds to step S60. A process to cancel the scramble of video audio scramble signal 201 received at broadcast information input unit 240 is carried out at descramble unit 220 (step S60).

When a descramble key has not been received, the process of step S60 is not carried out, and the process ends.

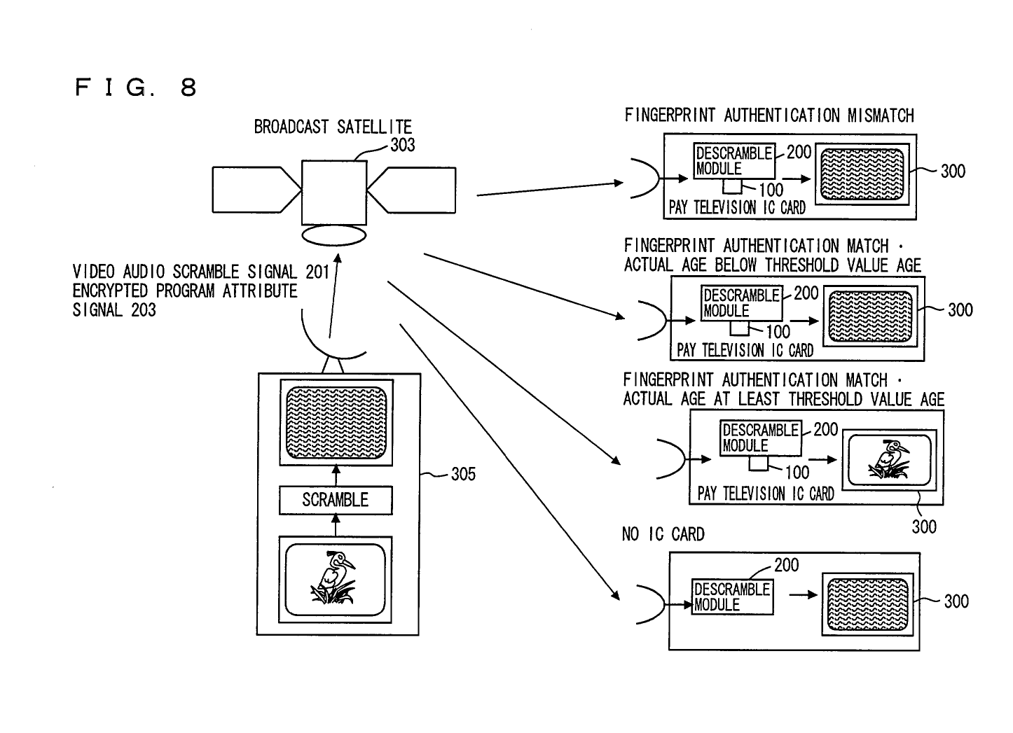

FIG. 8 is a diagram to describe the concept of the pay television system of the present embodiment. Referring to FIG. 8, the video audio scramble signal subjected to a scramble process and transmitted from broadcast station 305 and the encrypted program attribute signal transmitted from broadcast station 305 are received at descramble module 200 via broadcast satellite 303.

Consider the first example corresponding to fingerprint authentication failure. In the first example, determination is made that the registrant recorded in pay television IC card 100 is not identical to the user. The scramble of video audio scramble signal 201 is not canceled when the fingerprint information of the registrant stored in pay television IC card 100 does not match or is not similar to the fingerprint information obtained by reading out the fingerprint of the user. Therefore, the video and audio will not be output to television set 300.

The second example corresponds to the case where fingerprint authentication is successful and the actual age of the user is lower than the age threshold value. Although determination is made that the registrant recorded in pay television IC card 100 is identical to the user, the program target age obtained from the program target age information included in the program attribute signal is higher than the actual age of the user. The age of the user is below the program target age that is allowed of audience of the program included in the program attribute signal even though determination is made that the user is the same person as the registrant. In this case, scramble of video audio scramble signal is not canceled. Neither the video nor audio will be output at television set 300.

The third example corresponds to the case where fingerprint authentication is successful and the actual age is at least the age threshold value. Determination is made that the registrant recorded in pay television IC card 100 is identical to the user, and the actual age of the user is equal to or above the program target age included in the program attribute signal. In this case, scramble of the video audio scramble signal is canceled. The video and audio is output from television set 300.

The fourth example corresponds to the case where there is no IC card. No pay television IC card 100 is inserted into descramble module 200. In this case, a set up completion signal is not output from pay television IC card 100. Therefore, descramble module 200 does not attain an active state. The scramble of the video audio scramble signal is not canceled. Thus, neither the video nor audio will be output from television set 300.

Since determination of the sameness between the user and the registrant is based on the fingerprint which is the physical description of a person in the pay television system of the present embodiment, the person who can use the pay television IC card 100 can be restricted to only the person who is registered. As the physical description data, the iris, voice print, or the like can be employed instead of a fingerprint. Furthermore, determination of the sameness of a person can be made based on a process on an image of a person's face that is shot.

Since the data of a plurality of persons can be registered in the registrant database of storage unit 120 of pay television IC card 100, one pay television IC card 100 can be shared among a plurality of persons. Since determination of the sameness between a registrant recorded in pay television IC card 100 and the user is made based on an image obtained by reading out the fingerprint which is physical description data of a person, determination of the same person can be conducted at high accuracy.

By virtue of the high accuracy of determination of sameness between the user and the registrant, descramble can be reliably inhibited with respect to the usage of a person of an age that is not permitted audience of an age-restricted program.

Since the actual age of the user is calculated based on the date of birth data and the current date data, it is not necessary to modify the age information. Maintenance of the stored information can be simplified.

Furthermore, since another registrant can be registered only on the condition that the fingerprint of a master registrant is input, only a person that is authorized by the master registrant can be registered as a registrant.

The above embodiment was described based on a pay television IC card 100 and a descramble module 200. Alternatively, the process executed by the pay television IC card 100 shown in FIG. 6 and the process executed by the descramble module 200 shown in FIG. 7 may be implemented as programs executed by a computer. In this case, the program to execute the processes shown in FIGS. 6 and 7 is stored in recording medium 199 or 299, and read out to control unit 210 of pay television IC card 100 or control unit 110 of descramble module 200 to be executed.

Such recording media 199 and 299 can include a magnetic tape, a cassette tape, a magnetic disk (flexible disk, hard disk, etc.), an optical disk (CD-ROM/MO/MD/DVD, etc.), an IC card (including a memory card), an optical card, and a semiconductor memory such as a mask ROM, EPROM, flash memory, and the like. Recording media 199 and 299 can also be employed as a carrier medium in downloading a program from the network.

Second Embodiment

In the previous first embodiment, pay television IC card 100 and descramble module 200 are provided as individual units. In the second embodiment of the present invention, pay television IC card 100 and descramble module 200 are integrally formed as a descrambler 400.

The descrambler of the second embodiment is supplied by the pay television service provider when a subscriber who wishes to receive the service of a pay television system applies for authorized viewing of pay television. The pay television service provider records the date of birth information and secret identification code in storage unit 120 in correspondence with the service number of the subscriber before the descrambler is delivered to the subscriber.

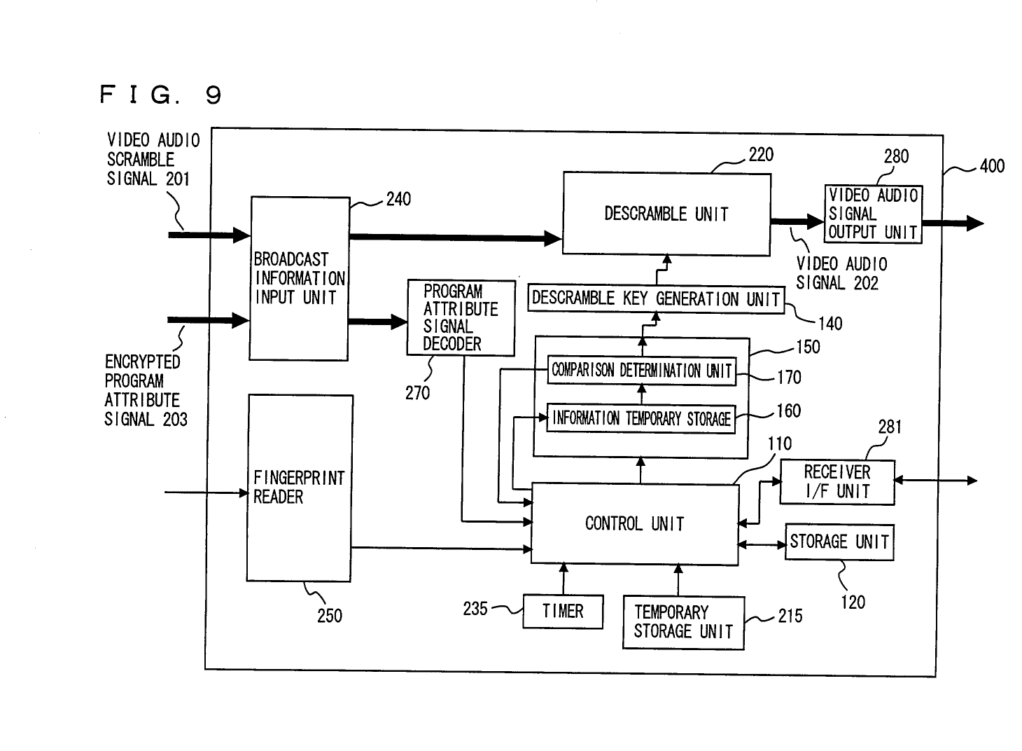

FIG. 9 is a block diagram of a schematic structure of the descrambler of the second embodiment. Referring to FIG. 9, descrambler 400 includes a control unit 110 to control the entirety of descrambler 400, a broadcast information input unit 240 to receive video audio scramble signal 201 and encrypted program attribute signal 203 from a broadcast station, a program attribute signal decoder 270 to decode encrypted program attribute signal 203 received by broadcast information input unit 240, a fingerprint reader 250 to read out the fingerprint of the user and providing fingerprint information to control unit 110, a timer 235 to count the current date and time, a storage unit 120 to store a registrant database, an information temporary storage unit 160, a comparison determination unit 170 to determine that sameness between the registrant and the user as well as to determine that the actual age of the user is at least the program target age, a descramble key generation unit 140 to generate a descramble key according to a comparison determination result of comparison determination unit 170, a descramble unit 220 to cancel the scramble of video audio scramble signal 201 based on the descramble key output at descramble key generation unit 140, and a video audio signal output unit 280 to output the video audio scramble signal descrambled at descramble unit 220 to television set 300.

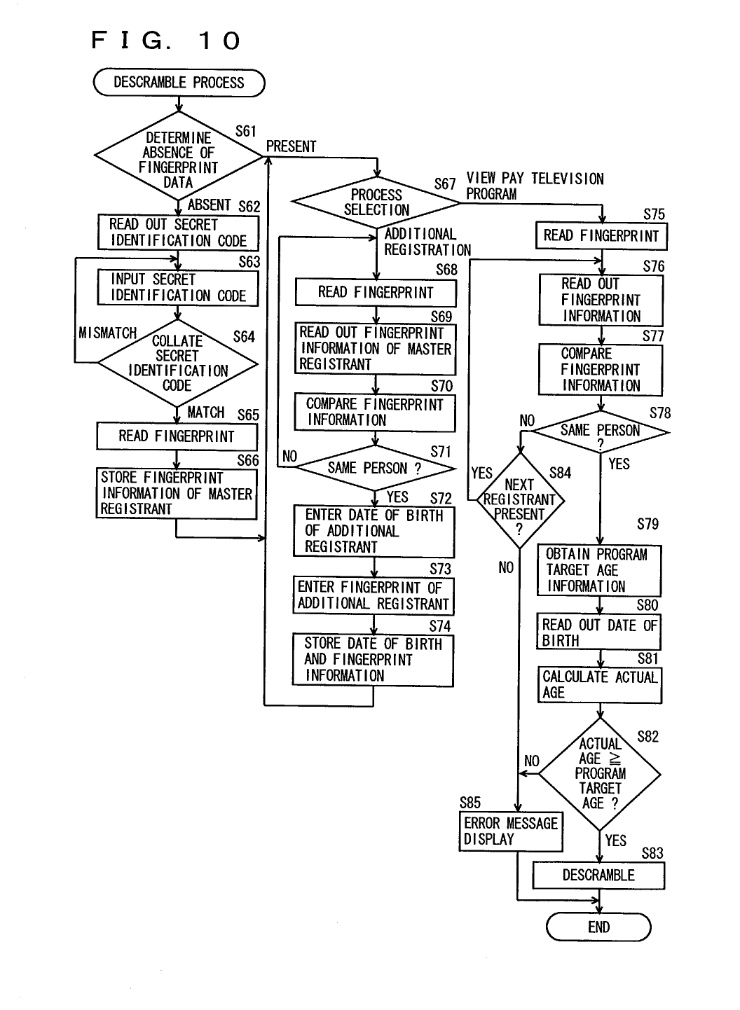

FIG. 10 is a flow chart of the descramble process executed by descrambler 400 according to the second embodiment. In the descramble process, determination is made whether fingerprint data is stored in the registrant database in storage unit 120 (step S61). When at least one fingerprint data is registered, control proceeds to step S67, otherwise, to step S62.

At step S62, the secret identification code prestored in the registrant database in storage unit 120 is read out. A screen including an image prompting input of a secret identification code is output to television set 300 via a video audio signal output unit 280. Receiver I/F unit 281 receives the secret identification code input through a numeric input unit such as the remote controller of television set 300 (step S63).

The secret identification code received at step S63 is collated with the secret identification code read out from storage unit 120 at step S62 (step S64). When the secret identification codes match, control proceeds to step S65, otherwise, to step S63.

At step S65, a screen prompting entry of the fingerprint is output to television set 300 from video audio signal output unit 280. The fingerprint is read out by finger printer reader 250 (step S65). The fingerprint read by fingerprint reader 250 is converted into fingerprint information in the form of electronic data to be transmitted to control unit 110.

At control unit 110, the received fingerprint information is stored as the fingerprint information of the master registrant in the registrant database (step S66). Then, control proceeds to step S67.

At step S67, a screen including the message of “VIEW PAY TELEVISION PROGRAM” and the message of “REGISTRATION OF NEW USER” is output from video audio signal output unit 280 to television set 300. The user selects either process by entering a value through a numeric input unit such as a remote controller, whereby information of which process has been selected is received at receiver I/F unit 281. Control unit 110 determines whether an additional registration process or a pay television view process has been selected (step S67). When an additional registration process is selected, control proceeds to step S68, otherwise, to step S75.

At step S68, a screen including a message of, for example, “Please enter fingerprint” is transmitted to television set 300 from video audio signal output unit 280. The user enters his/her fingerprint through fingerprint reader 250 according to the displayed message. On this occasion, the input fingerprint is the fingerprint of the master registrant.

At step S69, the fingerprint information of the master registrant stored in storage unit 120 is read out. The fingerprint information obtained by reading out the fingerprint of the user at step S68 is compared with the fingerprint information of the master registrant read out at step S69 (step S70).

At step S71, determination is made whether the user and the master registrant are the same person, based on the comparison result. When determination is made of the sameness, control proceeds to step S72, otherwise, to step S68.

At step S72, a screen including a message of, for example, “Please enter date of birth and fingerprint of additional registrant” is output to television set 300 via video audio signal output unit 280. The user enters the date of birth through a numeric unit such as a remote controller, which is received at receiver I/F unit 281 (step S72). The fingerprint of the additional registrant is read by fingerprint reader 250 (step S73).

Thus, the date of birth and fingerprint information of the additional registrant are newly stored in the registrant database in storage unit 120 (step S74).

When a pay television view process is selected at step S67, control proceeds to step S75. The fingerprint of the user is read by a fingerprint reader 250 to be stored in information temporary storage unit 160.

At step S76, fingerprint information stored in the registrant database in storage unit 120 is sequentially read out. The fingerprint information of the user obtained by the read out at step S75 is compared with the fingerprint information of the registrant read out from storage unit 120 at step S76 (step S77). Determination is made whether the user is the same person as the registrant based on the comparison result (step S78). In the case where the user and the registrant are the same person, control proceeds to step S79, otherwise, to step S84.

At step S79, the program target age information is obtained by program attribute signal decoder 270 (step S79). The date of birth of the registrant corresponding to the fingerprint information read out at step S76 is read out from storage unit 120 (step S80). The actual age of the registrant is calculated from the current date obtained from timer 235 and the date of birth read out from storage unit 120 (step S81). In the case where the actual age information is stored in the registrant database in storage unit 120, the actual age information is read out from storage unit 120. In this case, the process of steps S80 and S81 is not required.

Determination is made whether the calculated actual age is at least the program target age obtained at step S79 (step S82). When determination is made that the actual age is equal to or above the program target age, control proceeds to step S83, otherwise, to step S85.

At step S83, a descramble key is generated at descramble key generation unit 140. At descramble unit 220, the scramble of video audio scramble signal 201 is canceled using the generated descramble key. The descrambled video audio scramble signal is output to television set 300 from video audio signal output unit 280 (step S83).

When determination is made that the user and the registrant are not the same person at step S78, control proceeds to step S84. Determination is made whether a next registrant is recorded in the registrant database in storage unit 120. In the case where there is a next registrant, control proceeds to step S76. The process from steps S76 to step S78 is carried out for the next registrant. In the case where there is no next registrant, control proceeds to step S85. An error message is output from video audio signal output unit 280 to television set 300.

Since determination of the sameness between the registrant and the user is made based on the fingerprint which is the physical description in the descrambler of the second embodiment, usage of the descrambler can be reliably restricted to the intended end user.

Also, since a plurality of persons admitted of usage of the descrambler can be registered, pay television can be viewed by any of the registrants just through fingerprint entry.

Furthermore, since determination of the sameness between a user and a registrant is based on a fingerprint, the descramble operation by users below a specified age with respect to age-restricted programs can be inhibited reliably.

Third Embodiment

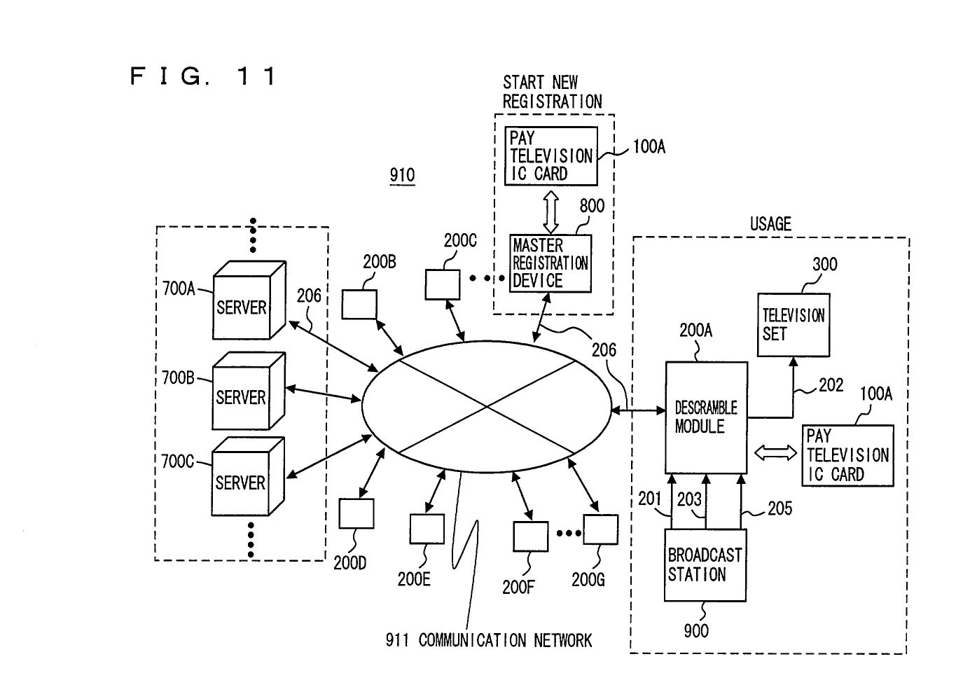

Referring to FIG. 11, a pay television system 910 according to a third embodiment of the present invention includes server devices 700A, 700B and 700C, a master register device 800, and descramble modules 200A, 200B, 200C, 200D, 200E, 200F and 200G.

Although three server devices 700A, 700B and 700C, one master registration device 800, and seven descramble modules 200A, 200B, 200C, 200D, 200E, 200F and 200G are shown in FIG. 11, the number of units thereof are arbitrary, as long as there is at least one of respective units.

In pay television system 910 of the third embodiment, the usage count of pay television IC card 100A is administered by any of server devices 700A, 700B and 700C. For the sake of simplification, description is based on the case where server device 700A conducts the administration. The usage count of pay television IC card 100A is administered based on a predetermined usage admitted count assigned at the time of purchasing pay television IC card 100A. The predefined usage admitted count is decreased according to the count of the viewed pay television program transmitted from broadcast station 900. Pay television IC card 100A can be used until the usage admitted count defined thereto becomes lower than the count corresponding to the pay television program (required count).

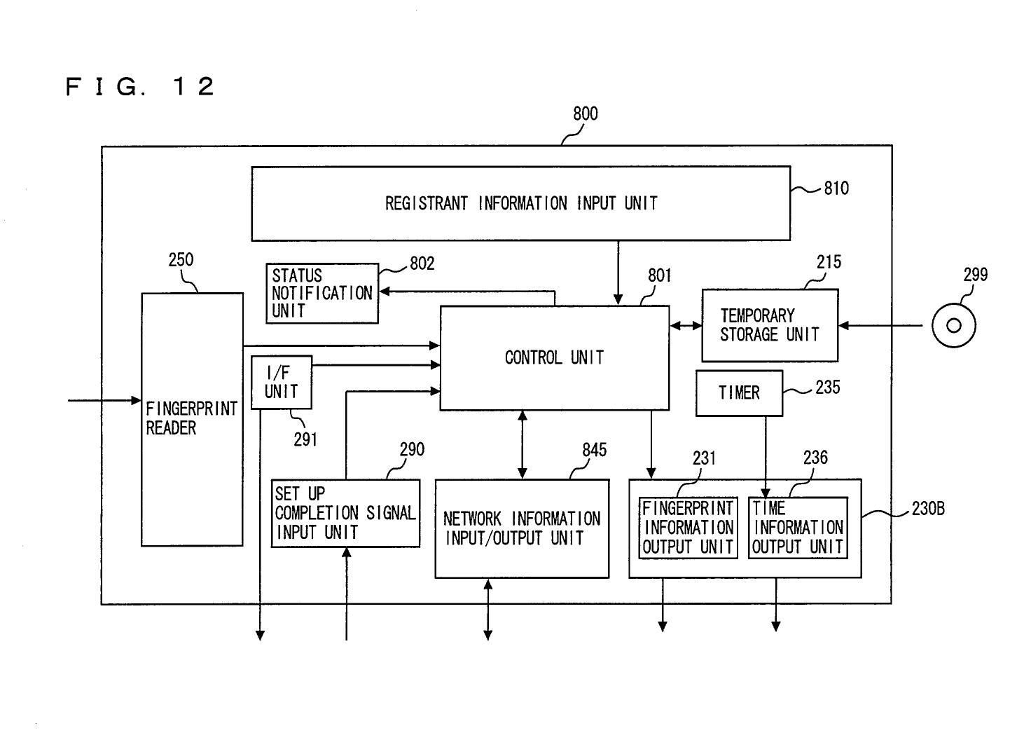

FIG. 12 is a block diagram of a schematic structure of master registration device 800 of the third embodiment. Referring to FIG. 12, master registration device 800 includes a control unit 801 to control the entirety of master registration device 800, a temporary storage unit 215 used as a work area during execution of a program by control unit 801, a registrant information input unit 810 to apply registrant information to be recorded into pay television IC card 100A, a fingerprint reader 250 to read the fingerprint of a registrant, an interface unit (I/F unit) 291 to transfer the required information with respect to pay television IC card 100A, a set up completion signal input unit 290 to receive a set up completion signal, a timer 235 to count the time, a data output unit 230B to output fingerprint information and time information to pay television IC card 100A, a network information input/output unit 845 for communication with server device 700A via a communication network 911, and a status notification unit 802 to output required information such as the operation message to the user of the master register device (the clerk of a dealer) or the like.

Fingerprint reader 250 includes a charge coupled device (CCD) to pick up an image of the fingerprint of the purchaser of pay television IC card 100A (registrant). The fingerprint is converted into electrical image data and provided to control unit 801. The output image data based on the image of the read fingerprint from fingerprint reader 250 is called fingerprint information. Fingerprint information is temporarily stored in temporary storage unit 215, and then transmitted to pay television IC card 100A by fingerprint information output unit 231 or to several device 700A via network information input/output unit 845.

Set up completion signal input unit 290 receives the set up completion signal output from set up completion signal output unit 190 of pay television IC card 100A, and provides the set up completion signal to control unit 801. The set up completion signal indicates that pay television IC card 100A is connected to master registration device 800 and pay television IC card 100A attains an operable state. Therefore, determination can be made that pay television IC card 100A is inserted in master registration device 800 during the period of time a set up of completion signal is received from set up completion signal input unit 290 at control unit 801.

Registrant information input unit 810 receives input of individual information such as the date of birth, address, name and the like of the purchaser of pay television IC card 100A. Registrant information input unit 810 includes a keyboard, a tablet, or the like, and can be provided independent of master registration device 800. In this case, communication with master registration device 800 may be established through cable or radio connection.

Network information input/output unit 845 is the network interface to communicate with any of server devices 700A, 700B, and 700C. Communication between master registration device 800 and server devices 700A, 700B, and 700C is effected via network information input/output unit 845.

I/F unit 291 is connected to I/F 191 of pay television IC card 100A, that will be described afterwards. When a set up completion signal is supplied to set up completion signal input unit 290, input/output of predetermined information to/from pay television IC card 100A is allowed.

Timer 235 counts the current date and time. The output of timer 235 is provided to time information output unit 236 as the date and time information, and further provided to pay television IC card 100A from time information output unit 236.

Data output unit 230B includes a fingerprint information output unit 231 and a time information output unit 236. Fingerprint information output unit 231 outputs to pay television IC card 100A the fingerprint information read out by fingerprint reader 250 and stored in temporary storage unit 215. Time information output unit 236 outputs the current date from timer 235 to pay television IC card 100A.

Status notification unit 802 is a display or speaker to inform visually or audibly an error signal or instruction signal received from server device 700A or from pay television IC card 100A under control of control unit 801. By the visual or audible notification by status notification unit 802, the seller or purchaser of pay television IC card 100A is instructed of the next operation or provided with an error message in the process of purchasing a pay television IC card 100 that will be described afterwards.

Recording medium 299 records the program to be executed at control unit 801. Master registration device 800 reads out the program recorded in recording medium 299 to execute a process according to the read program.

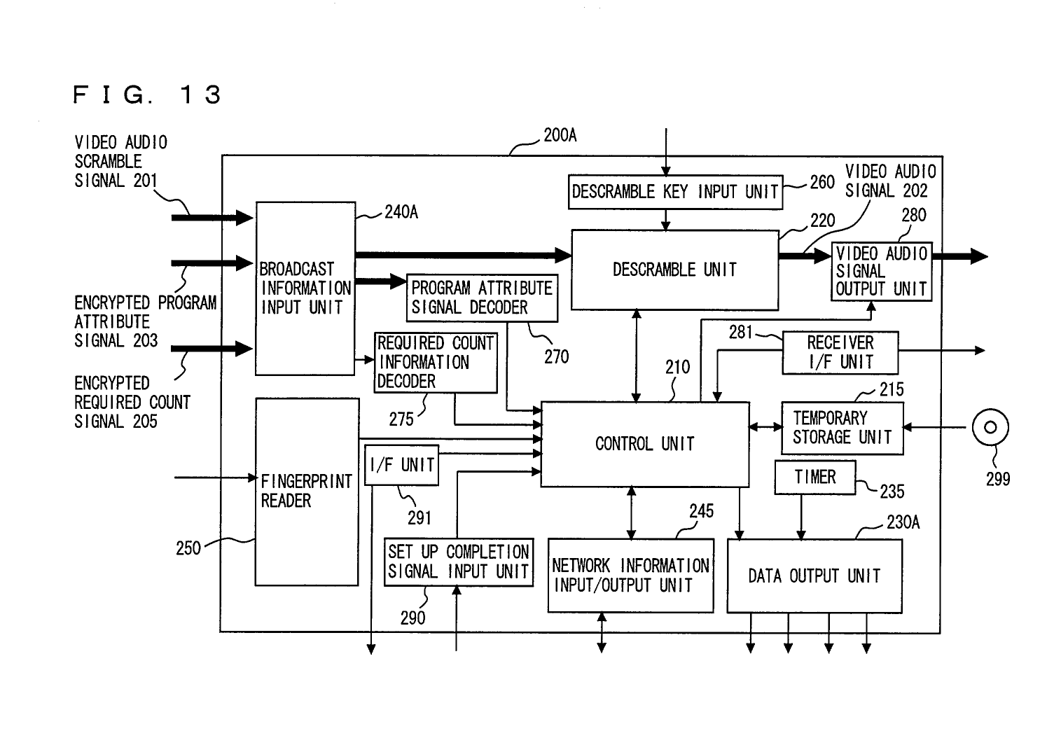

FIG. 13 is a block diagram of a schematic structure of descramble module 200A according to the third embodiment. Referring to FIG. 13, descramble module 200A includes a control unit 210 to control the entirety of descramble module 200A, a temporary storage unit 215 used as a work area during execution of a program or the like by control unit 210, a video audio scramble signal 201 transmitted from a broadcast station, a broadcast information input unit 240A receiving an encrypted program attribute signal 203 and an encrypted required count signal, a program attribute signal decoder 270 decoding encrypted program attribute signal 203, a required count information decoder 275 to decode encrypted required count signal 205, a descramble unit 220 to cancel the scramble of video audio scramble signal 201, a descramble key input unit 260 to receive a descramble key from pay television IC card 100A, a video audio signal output unit 280 to output video audio signal 202 from descramble unit 220 to television set 300, a receiver interface unit 281 to transfer/receive information to/from television set 300, a fingerprint reader 250 to read out the fingerprint of a user, an interface unit 291 to transmit/receive the required information to/from pay television IC card 100A, a set up completion signal input unit 290 receiving a set up completion signal, and a data output unit 230A to output fingerprint information, program target age information, time information, and an account enable signal to pay television IC card 100A.

Broadcast information input unit 240A receives encrypted program attribute signal 203 output from broadcast station 900, and encrypted required count signal 205 and video audio scramble signal 201. Broadcast information input unit 240A provides encrypted program attribute signal 203 to program attribute signal decoder 270, encrypted required count signal 205 to required count information decoder 275, and video audio scramble signal 201 to descramble unit 220.

Program attribute signal decoder 270 decodes encrypted program attribute signal 203 received from broadcast information input unit 240A, and provides the program attribute signal to control unit 210. The program attribute signal includes information related to the broadcasting program. For example, information to restrict the age of the audience of the program is included.

Required count information decoder 275 decodes encrypted required count signal 205 received from broadcast information input unit 240, and provides the required count signal to control unit 210. The required count signal includes the count value required to view the pay television program. The required count is a value corresponding to a pay television program, and subtracted from the usage admitted count defined in pay television IC card 100A when the pay television program is viewed. The required count of the required count signal is output to any of server devices 700A, 700B and 700C by network information input/output unit 245 that will be described afterwards.

Video audio scramble signal 201 is a signal having the video portion and audio portion scrambled. The video audio scramble signal is transmitted on a program-by-program basis. Information related to a program is the program attribute, included in the program attribute signal. The program attribute signal includes program target age information indicating a specified age when the audience of the program is limited in age. The program target age information from the program attribute signal is output to pay television IC card 100A from program target age information output unit 232 of data output unit 230A.

Descramble unit 220 cancels the scramble of video audio scramble signal 201 received from broadcast information input unit 240A. The descramble key required in canceling the scramble is received from a descramble key input unit 260. Therefore, descramble unit 220 cannot cancel the scramble of video audio scramble signal 201 unless a descramble key is received from the scramble key input unit 260. In other words, the scramble of video audio scramble signal 201 is canceled only when a descramble key is received by descramble key input unit 260, whereby a video audio signal 202 is output to video audio signal output unit 280.

Fingerprint reader 250 includes a charge coupled device (CCD) to pick up an image of the fingerprint of the user of descramble module 200A, which is converted into electrical image data to be output to control unit 210. Fingerprint information is temporarily stored in temporary storage unit 215. Fingerprint information is transmitted to pay television IC card 100A from fingerprint information output unit 231, or transmitted to server device 700A via network information input/output unit 845.

Descramble key input unit 260 receives a descramble key from pay television IC card 100A, and provides the descramble key to descramble unit 220. Descramble key input unit 260 outputs a descramble key to descramble unit 220 as long as a descramble key is received from pay television IC card 100A.

I/F unit 291 is connected to I/F unit 191 of pay television IC card 100A, and allows input/output of predetermined information to/from pay television IC card 100A.

Set up completion signal input unit 290 receives and provides to control unit 210 a set up completion signal output from set up completion signal output unit 190 of pay television IC card 100A. The set up completion signal indicates that pay television IC card 100A is connected to descramble module 200A, and pay television IC card 100A is operable. Therefore, determination can be made at control unit 210 that pay television IC card 100A is loaded at descramble module 200A during reception of a set up completion signal from set up completion signal input unit 290.

Timer 235 counts the current date and time. The output of timer 235 is provided to time information output unit 236 as the date and time information. This information is output to pay television IC card 100A from time information output unit 236.

Receiver I/F unit 281 receives numerical information input through a numeric input unit provided at television set 300. The received numeric information is provided to control unit 210. The numeric input unit provided at television set 300 includes an input button or remote controller furnished to television set 300. The input numeric information includes a secret identification code and date of birth. In order to prompt the user to input of numeric information, a screen prompting input can be output to television set 300 from video audio signal output unit 280.

Network information input/output unit 245 is a network interface to communicate with any of server devices 700A, 700B and 700C. Communication between descramble module 200A and server devices 700A, 700B and 700C is conducted via network information input/output unit 245.

Recording medium 299 records a program to be executed by control unit 210. Descramble module 200A reads out the program from recording medium 299 to execute a process according to the read program.

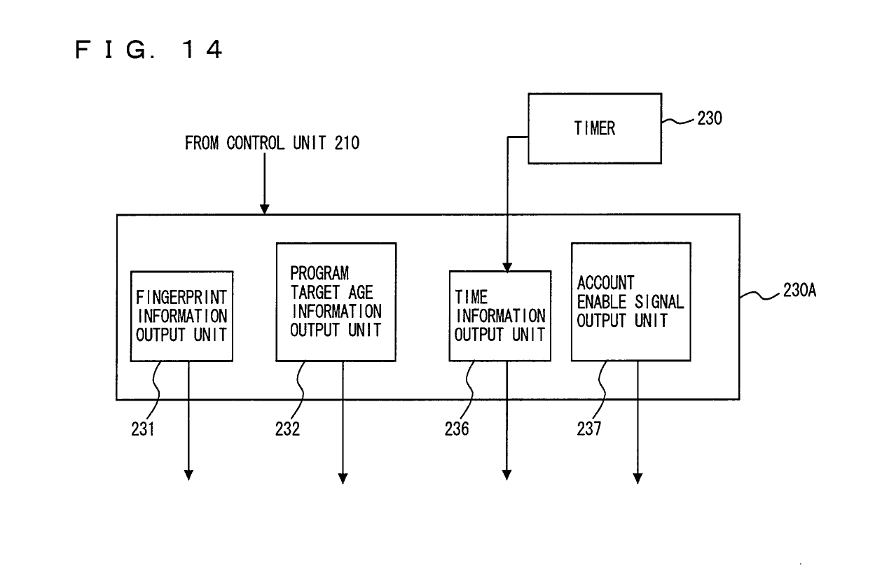

FIG. 14 is a block diagram showing a detailed structure of data output unit 230A of descramble module 200A. Referring to FIG. 14, data output unit 230A includes a print information output unit 231, a program target information output unit 232, a time information output unit 236, and an account enable signal output signal 237.

Fingerprint information output unit 231 provides the fingerprint information stored in temporary storage unit 215 to pay television IC card 100A. Program target age information output unit 232 provides program target age information from the program attribute signal decoded at program attribute signal decoder 270 to pay television IC card 100A. Time information output unit 236 outputs the current date counted by timer 236 to pay television IC card 100A. At account enable signal output unit 237, the account enable signal received from server device 700A at network information input/output unit 245 is provided to pay television IC card 100A.

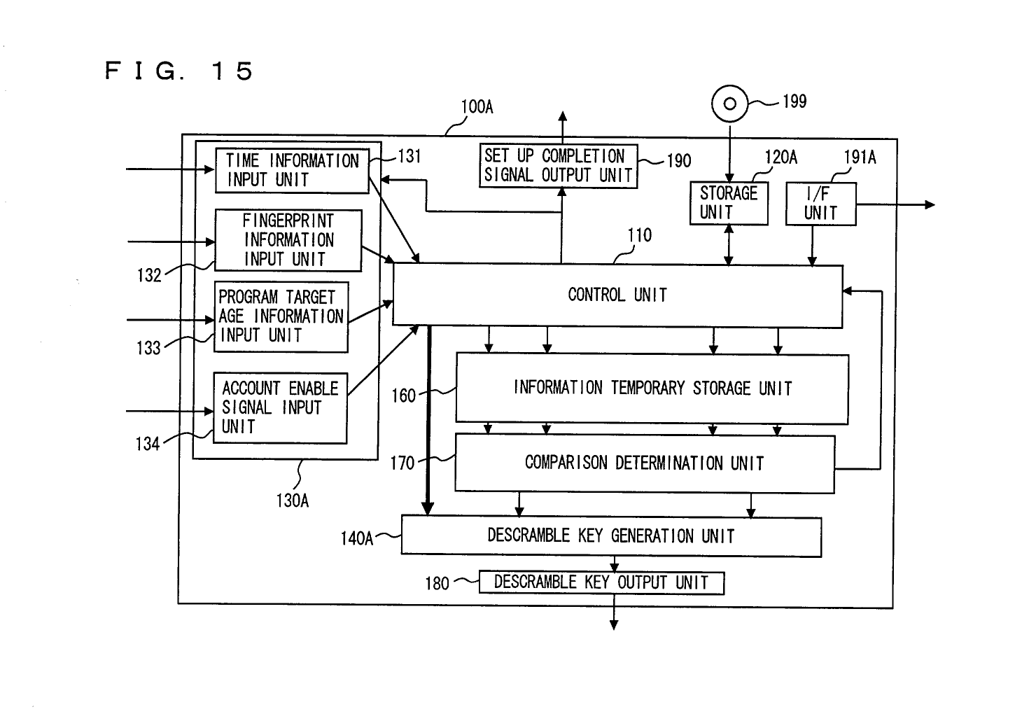

FIG. 15 is a block diagram showing a schematic structure of pay television IC card 100A of the third embodiment. Referring to FIG. 15, pay television IC card 100A includes a control unit 110 to control the entirety of pay television IC card 100A, a storage unit 120A to store information related to the registrant, a data input unit 130A to receive required information from master registration device 800 or descramble module 200A, a set up completion signal output unit 190 to output a set up completion signal when connection with master registration device 800 or descramble module 200A is established, an information temporary storage unit 160, a comparison determination unit 170 performing a comparison determination process based on information stored in information temporary storage unit 160, a descramble key generation unit 140A to generate a descramble key based on the comparison determination result from comparison determination unit 170, a descramble key output unit 180 to output the generated descramble key to descramble module 200A, and an interface unit 191A connected to master registration device 800 or descramble module 200A to input/output required information.

When the power of descramble module 200 and descramble module 200A is turned on and the user of pay television IC card 100A inserts the IC card into descramble module 200A, power is supplied from descramble module 200A to pay television IC card 100A. Pay television IC card 100A supplied with power is turned ON, and a reset operation is initiated. This reset operation is under control of control unit 110. Following completion of the power on and reset operation of pay television IC card 100A under control of control unit 110, a set up completion signal is output to set up completion signal input unit 290 from set up completion signal output unit 190.

When the clerk of the dealer of pay television IC card 100A inserts pay television IC card 100A into master registration device 800 after the power of master registration device 800 is turned ON, power is supplied from master registration device 800 to pay television IC card 100A. The powered pay television IC card 100A is turned ON, and a reset operation is initiated. This reset operation is under control of control unit 111. Upon completion of the power on and reset operation of pay television IC card 100A under control of control unit 110, a set up completion signal is output to set up completion signal input unit 290 from set up completion signal output unit 190.

Data input unit 130A includes a time information input unit 131, a fingerprint information input unit 132, a program target age information input unit 133, and an account enable signal output unit 134.

When pay television IC card 100A is inserted into descramble module 200A, time information input unit 131 is connected to time information output unit 236 of descramble module 200A to receive the current date and time counted at timer 235 from time information output unit 236. The received date and time information is output to control unit 110. When pay television IC card 100A is inserted into master registration device 800, time information input unit 131 is connected to time information output unit 236 of master registration device 800 to receive the current date and time counted at timer 235 from time information output unit 236.

When pay television IC card 100A is inserted into descramble module 200A, fingerprint information input unit 132 is connected with fingerprint information output unit 231 of descramble module 200A. Fingerprint information is received from fingerprint information output unit 231 to be provided to control unit 110. When pay television IC card 100A is inserted into master registration device 800, connection with fingerprint information output unit 231 of master registration device 800 is established. Fingerprint information is received from fingerprint information output unit 231 to be provided to control unit 110.

When pay television IC card 100A is inserted into descramble module 200A, program target age information input unit 133 is connected with program target age information output unit 232 of descramble module 200A. Program target age information is received from program target age information output unit 232 of descramble module 200A to be provided to control unit 110.

When pay television IC card 100A is inserted into descramble module 200A, account enable signal input unit 134 is connected with account enable signal output unit 237 of descramble module 200A. The account enable signal is received from account enable signal output unit 237 of descramble module 200A to be output to control unit 110.

Storage unit 120A includes a registrant database that records the person whose audience of a pay television program is admitted as a registrant. The registrant database has a service number assigned to each registrant, fingerprint information of the registrant, date of birth information, actual age information, address information, and name information stored in correspondence with each registrant. A server ID and a server password are stored in storage unit 120A. The contents stored in storage unit 120A will be described in detail afterwards.

Storage unit 120A is preferably a memory that cannot be rewritten once information is programmed. Preferably, storage unit 120A is a memory that requires a rewrite admission signal for rewriting, or a fuse type memory.

Information temporary storage unit 160 is a random access memory, temporarily storing fingerprint information of the user received at fingerprint information input unit 132, fingerprint information of the registrant stored in storage unit 120A, program target information received at program target age information input unit 133, and the actual age of the registrant stored in storage unit 120A.

Comparison determination unit 170 compares the fingerprint information obtained by reading out the fingerprint of the user with the fingerprint information of the registrant stored in storage unit 120A to determine whether the user and the registrant are the same person. When program target age information is stored in information temporary storage unit 160, comparison determination unit 170 compares the program target age information with the actual age of the registrant stored in storage unit 120A. Comparison determination unit 170 outputs an admission signal to descramble key generation unit 140 when determination is made of the sameness between the user and the registrant, or in the case where program target age information is stored in information temporary storage unit 160, when determination is made that the user is the same person as the registrant and the actual age is equal to or higher than the value of the program target age information. The details of comparison determination unit 170 has been described with reference to FIG. 5 already. Therefore description will not be repeated here.

Descramble key generation unit 140A generates a descramble key on the condition that an admission signal is received from comparison determination unit 170 and an account enable signal is received from control unit 110. The generated descramble key is output to descramble key output unit 180. In the case where key information to generate a descramble key is transmitted from a transmission station, the transmitted key information is received, and a descramble key is generated using the received key information.

Descramble key output unit 180 outputs the received descramble key to descramble input unit 260 of descramble module 200A.

Recording medium 199 stores the program to be executed by control unit 110. Pay television IC card 100A reads out the program from recording medium 199 to execute the process according to the read out program.

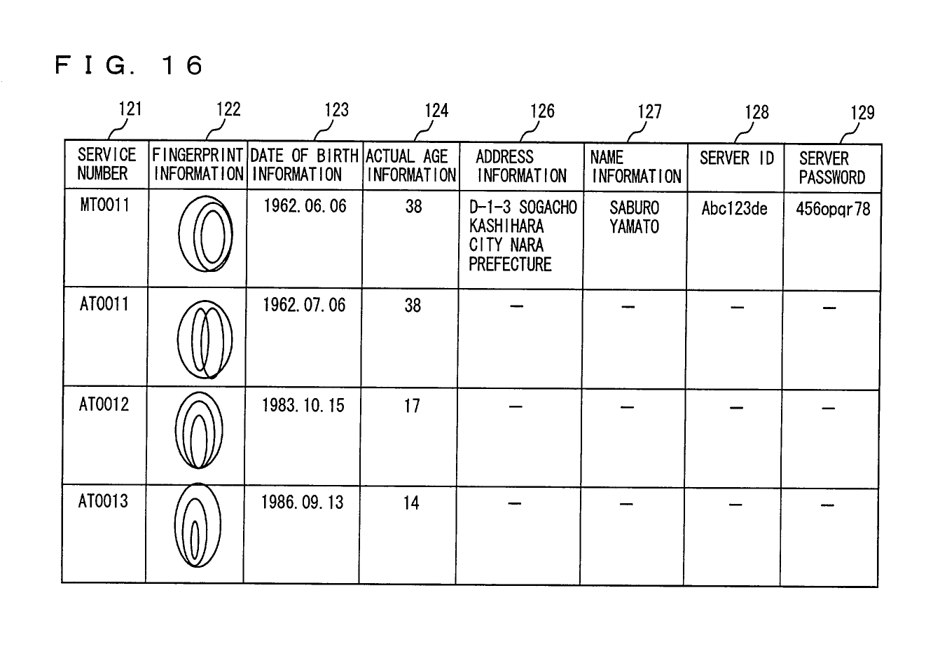

FIG. 16 is a diagram to describe information stored in storage unit 120A of pay television IC card 100 of the third embodiment. Referring to FIG. 16, a service number 121, print information 122, date of birth information 123, and actual age information 124 are stored for each registrant in storage unit 120A. Also, address information 126 and name information 127 are stored for the master registrant. Furthermore, a server ID 127 and a server password 128 of corresponding server device 700A is stored in descramble module 200A. The master registrant is the person whose information is stored in server 700A by master registration device 800 when pay television IC card 100A is purchased. Registration to server 700A will be described afterwards.

Service number 121 of the master registrant is a card identification number to identify pay television IC card 100A. Server ID 127 is the identification number to identify server device 700A that administers the usage admitted count assigned to pay television IC card 100A. The server password is a password to verify whether the pay television IC card is a proper one or not at server devices 700A, 700B and 700C. Service number 121 of the master registrant, the server ID and server password are assigned to each pay television IC card 100A and stored in storage unit 120A before pay television IC card 100A is sold. A different service number of the master registrant is assigned for each pay television IC card 100A. In the present invention, the service number can include symbols in addition to numbers.

A service number 121 for a registrant other than the master registrant is assigned for each registrant by control unit 110. Service number 121 differs for each registrant in the registrant database.

Therefore, pay television IC card 100A has the master registrant service number 121, server ID and server password stored in storage unit 120A, at the stage prior to being sold. This information can also be stored by server device 700A that administers the usage admitted count of pay television IC card 100A.

Fingerprint information 122 of the master registrant is the fingerprint information obtained by reading the fingerprint of a registrant through fingerprint reader 250 of master registration device 800. The date of birth information 123, address information 126, and name information 127 of the master registrant are the date of birth information, address information, and name information input through registrant information input unit 810 of master registration device 800.

Fingerprint information of a registrant other than the master registrant is the fingerprint information obtained by reading the fingerprint of a registrant through fingerprint reader 250 of descramble module 200A, as will be described in the registration process of an additional registrant. Date of birth information 123 is input through a numeric input unit such as a remote controller to be received at receiver I/F unit 281 to be stored.

Actual age information 124 is calculated and stored based on the date of birth information and date information of the registration date by control unit 110. Control unit 110 calculates the actual age of the registrant using the current date received from time information input unit 131 and date of birth information 123 stored in storage unit 120A. The actual age is stored in the region of actual age information 124 of the registrant database in storage unit 120A. Calculation of the actual age information by control unit 110 may be carried out every time power is supplied to pay television IC card 100A, or at a predetermined interval, for example, every day.

FIG. 16 corresponds to the case where four registrants are recorded in the registrant database. The registrant whose service number is “MT0011” is the master registrant. The data of the master registrant includes address information 126 and name information 127 in addition to fingerprint information 122, date of birth information 123 and actual age information 124. The registrants whose service numbers are “AT0011”, “AT0012” and “AT0013” are additional registrants. The data of the additional registrant includes a service number, fingerprint information, date of birth information and actual age information.

FIG. 16 shows an example where data of three additional registrants are stored in addition to the data of the master registrant. The registrant database does not necessarily have to store data of an additional registrant. Data of at least the master registrant is to be stored.

Server devices 700A, 700B and 700C will be described hereinafter. Server devices 700A, 700B and 700C can be formed of personal computers. Since each capability is identical, description of service device 700A will be provided representative thereof.

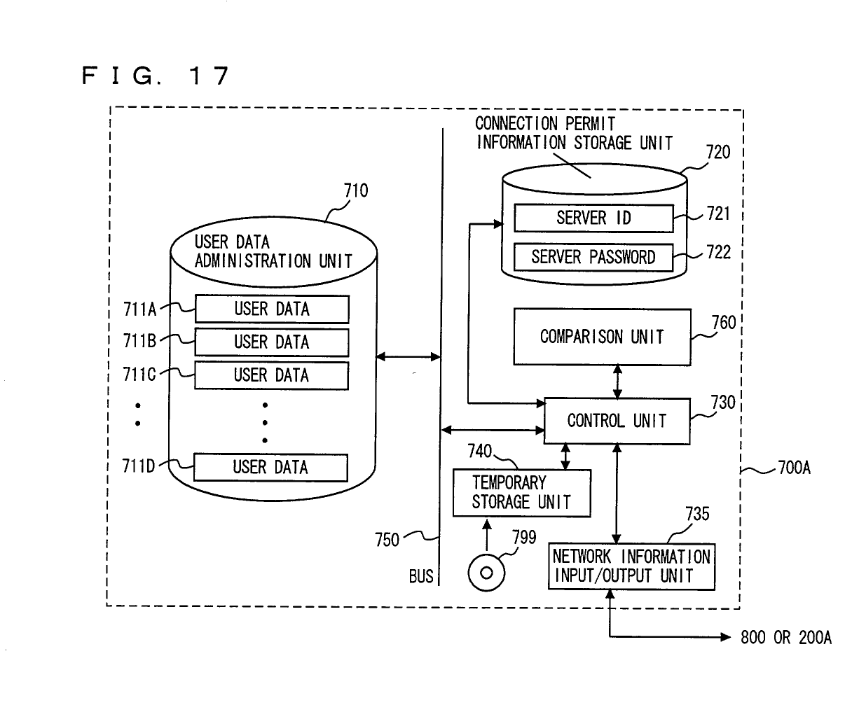

FIG. 17 is a block diagram of schematic structure of server device 700A of the third embodiment. Referring to FIG. 17, server device 700A includes a control unit 730 to control the entirety of server device 700A, a network information input/output unit 735, a user data administration unit 710 connected to control unit 730 via bus 750, a connection permit information storage unit 720 directly connected to control unit 730, a temporary storage unit 170 used as a work area during execution of a program by control unit 801, and a comparison unit 760.

Network information input/output unit 735 is a network interface to communicate with master registration device 800 or descramble module 200A. Communication between server device 700A and master registration device 800 or descramble module 200A is effected via network information input/output unit 735.

Connection permit information storage unit 720 stores a server ID 721 and a server password 722, which are assigned to server device 700A, in a one-to-one correspondence. Server ID 721 and server password 722 stored in connection permit information storage unit 720 are information used to enable access to server device 700A.

As mentioned above, server ID 128 and server password 129 are stored in storage unit 120A of pay television IC card 100A. At master registration device 800 or descramble module 200A, server ID 128 and server password 129 stored in storage 120A of pay television IC card 100A are received. The server device that administers the usage admitted count of pay television IC card 100A is identified based on server ID 128. The received server ID 128 and server password 129 are transmitted to the identified server device. At the server device, the received server ID 128 and server password 129 are collated with server ID 701 and server password 722, respectively, stored in connection permit information storage unit 720 to determine whether access from master registration device 800 or descramble module 200A is allowed or not. When access is accepted, access to user data administration unit 710 is allowed.

In the present embodiment, it is assumed that the server device identified by server ID 128 is server device 700A.

Comparison unit 760 includes a service number comparison unit 761, a server ID comparison unit 762, a count comparison unit 763, a server password comparison unit 764, a name information comparison unit 765, a fingerprint information comparison unit 766, an address information comparison unit 767, and a date of birth information comparison unit 768.

User data administration unit 710 stores user data. The user data is stored corresponding to the number of pay television IC card 100A that has the usage admitted count administered at server device 700A.

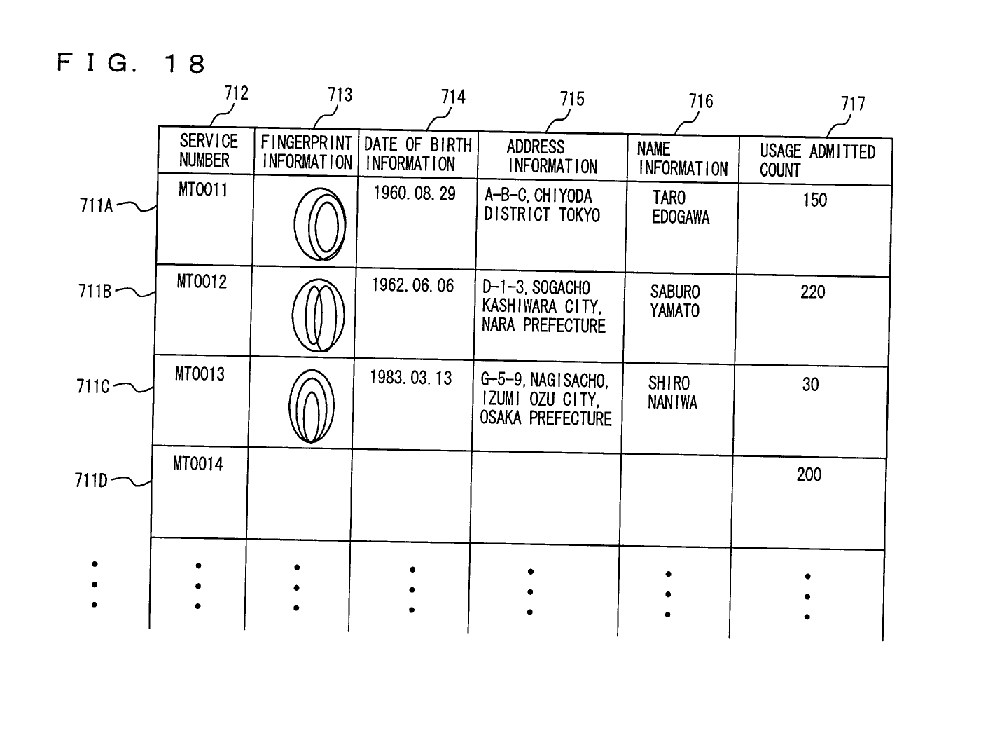

FIG. 18 shows an example of user data stored in user data administration unit 710 of the server device in the third embodiment. User data administration unit 710 stores user data including service number 712, fingerprint information 713, date of birth information 714, address information 715, name information 716, and usage admitted count 717. Service number 712 is a number required to identify pay television IC card 100A. Since this service number is assigned for each pay television IC card 100A, a plurality of user data corresponding in number to the number of pay television IC card 100A will be stored. Service number 712 is stored in storage unit 120A of pay television IC card 100A and in user data administration unit 710 before pay television IC card 100 is sold. Therefore, pay television IC card 100A loaded in master registration device 800 or descramble module 200A can be identified by server device 700A based on the service number received from master registration device 800 or descramble module 200A.

Usage admitted count 717 is assigned to pay television IC card 100A, indicating the count allowed of audience of a pay television program through pay television IC card 100A. The usage admitted count has the count corresponding to the viewed pay television program subtracted and updated every time a pay television program is viewed using pay television IC card 100A. This process will be described afterwards. The initial value of the usage admitted count is recorded in user data administration unit 710 before pay television IC card 100A is sold.

Fingerprint information 713, date of birth information 714 and address information 715 are the fingerprint information, date of birth, and address of the master registrant input at registrant information input unit 810 of master registration device 800. Fingerprint information 713, date of birth information 714 and address information 715 are stored in user data administration unit 710 at the time when pay television IC card 100A is sold.

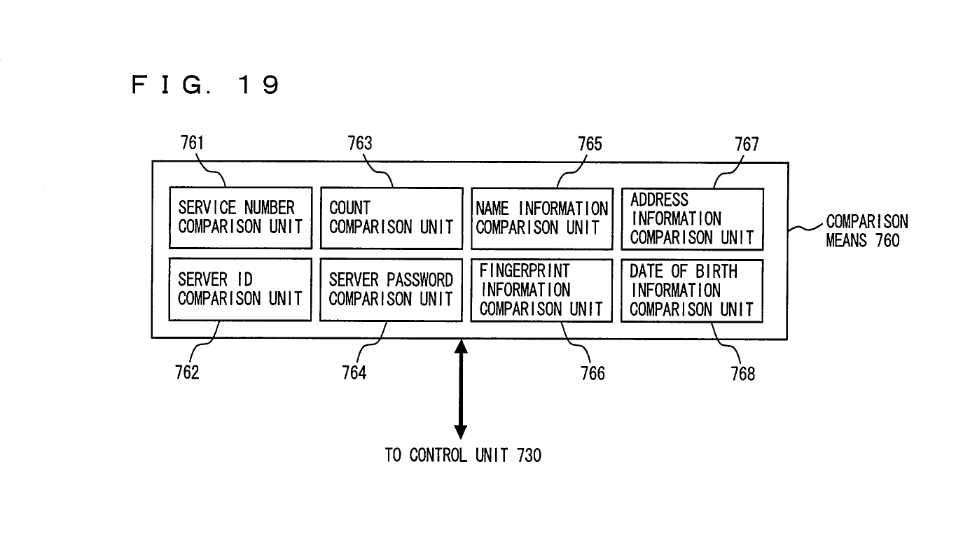

FIG. 19 is a block diagram of a detailed structure of comparison unit 760 of server device 700A. Referring to FIG. 19, comparison unit 760 includes a service number comparison unit 761, a server ID comparison unit 762, a count comparison unit 763, a server password comparison unit 764, a name information comparison unit 765, a fingerprint information comparison unit 766, an address information comparison unit 767, and a date of birth information comparison unit 768.

Service number comparison unit 761 compares service number 712 of the user data stored in user data administration unit 710 with service number 121 of the master registrant stored in storage unit 120A of pay television IC card 100A. Service number 121 of the master registrant is transmitted from master registration device 800 or descramble module 200A.

Server ID comparison unit 762 compares server ID 721 stored in connection permit information storage unit 720 with server ID 128 stored in storage unit 120A of pay television IC card 100A. Server ID 128 stored in storage unit 120A of pay television IC card 100A is transmitted from master registration device 800 or descramble module 200A.

Count comparison unit 763 compares usage admitted count 717 of the user data stored in user data administration unit 710 with the required count received from descramble module 200A.

Server password comparison unit 764 compares server password 722 stored in connection permit information storage unit 720 with server password 129 stored in storage unit 120A of pay television IC card 100A. Server password 129 stored in storage unit 120A of pay television IC card 100A is transmitted from master registration device 800 or descramble module 200A.

Name information comparison unit 765 compares name information 716 of the user data stored in user data administration unit 710 with the name information received from master registration device 800.

Fingerprint information comparison unit 766 compares fingerprint information 713 of the user data stored in user data administration unit 710 with fingerprint information transmitted from master registration device 800 or descramble module 200A. Fingerprint information is transmitted from master registration device 800 when pay television IC card 100A is newly purchased. Fingerprint information is transmitted from descramble module 200A when a program is to be watched using pay television IC card 100A.

Address information comparison unit 767 compares the user data address information 715 stored in user data administration unit 710 with the address information received from master registration device 800.

Date of birth information comparison unit 768 compares date of birth information 714 of the user data stored in user data administration unit 710 with the date of birth information received from master registration device 800.

Comparison unit 760 may be embodied by hardware, or by executing software through control unit 730.

Recording medium 799 stores the program to be executed by control unit 730. Server device 700A reads out the program stored in recording medium 799 to execute a process according to the program read out.

(1) Process when Pay Television IC Card 100A is Purchased

The process executed by pay television system when pay television IC card 100A is purchased according to the third embodiment will be described hereinafter.

The user purchases a pay television IC card 100 at a dealer where master registration device 800 is installed. On this occasion, pay television IC card 100A that is to be sold is loaded in master registration device 800. Communication is effected between master registration device 800 and server device 700A, whereby a process of correlating pay television IC card 100A that is the selling object with the user is executed. Here, description is based on server device 700A. In the case where the usage admitted count of pay television IC card 100A is administered by another server device 700B or 700C, communication is established between master registration device 800 and the server device that administers the usage admitted count.

Pay television IC card 100A is easily detachable with respect to master registration device 800. Pay television IC card 100A receives power from master registration device 800 by being loaded to master registration device 800. Connection between pay television IC card 100A and master registration device 800 may be established by the non-contact type or contact type connection method.

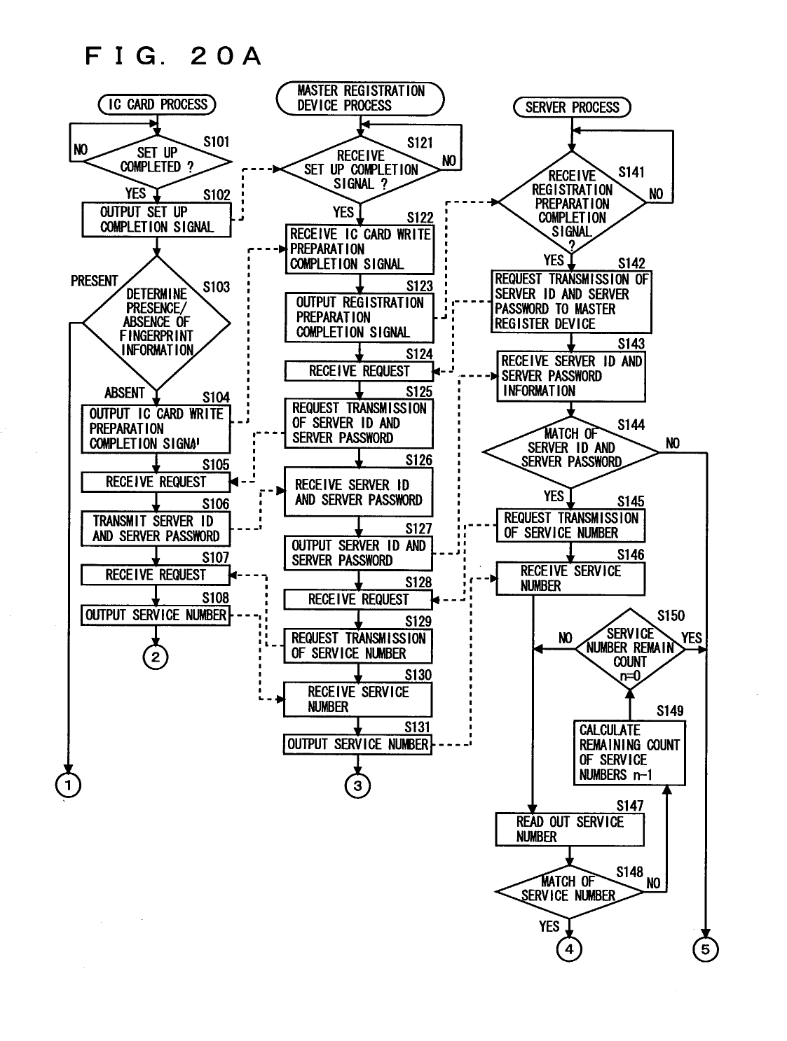

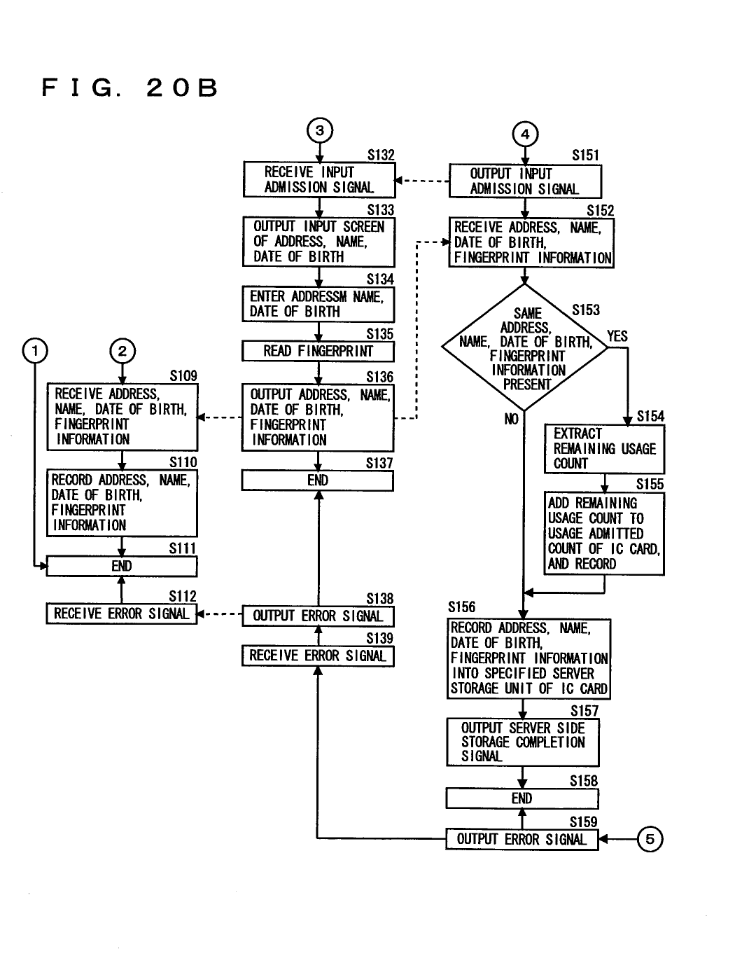

FIGS. 20A and 20B are flow charts of the process executed at pay television system of the third embodiment when pay television IC card 100A is to be purchased. In FIGS. 20A and 20B, respective processes executed at pay television IC card 100A, master registration device 800 and server device 700A are shown. The dotted line in FIGS. 20A and 20B denotes the data flow.

A user purchases a pay television IC card 100A at the dealer where master registration device 800 is installed. On this occasion, the purchaser submits an ID card or the like that has his/her address, name and date of birth described at the dealer. The name, address and date of birth are information required for registration by server device 700A.

The clerk of the dealer turns on the power of master registration device 800, and establishes in advance a connectable state with server devices 700A, 700B and 700C via communication network 911. Upon inserting pay television IC card 100A into master registration device 800 at this stage, power is supplied from master registration device 800 to pay television IC card 100A. Pay television IC card 100A to which power is supplied is powered on, i.e. a reset operation is initiated. This operation is under control of control unit 110. Then, determination is made whether set up has been completed or not (step S101). This determination is based whether the power on and reset operation has been completed or not. When the set up operation has been completed, a set up completion signal is output to master registration device 800 from set up completion signal output unit 190 (step S102).

When pay television IC card 100A does not attain a set up state, a signal indicating an inactive state is output from set up completion signal output unit 190. In an inactive state, data input unit 130A provided in pay television IC card 100A and data output unit 230B in master registration device 800 are both inactive. This means that an input signal cannot be accepted at control unit 110 even if an externally applied input signal is provided. No information is output from data output unit 230B.

When appropriate, a set up completion signal indicating an active state is output from set up completion signal output unit 190, which is received at set up completion signal input unit 290 of master registration device 800 (step S121). Then, control proceeds to step S122. Accordingly, data input unit 130A of pay television IC card 100A and data output unit 230B of master registration device 800 both attain an active state. Information can be transferred between pay television IC card 100A and master registration device 800.

At pay television IC card 100A, determination is made whether fingerprint information 120 is stored in storage unit 120A (step S103). When fingerprint information 122 is stored, the process ends (step S111), otherwise, control proceeds to step S104.

At the stage before pay television IC card 100A is sold, a service number 121 to identify pay television IC card 100A (the service number of the master registrant), server ID 128 and server password 129 are stored in storage unit 120A. Fingerprint information 122, date of birth information 123, actual age information 124, address information 126 and name information 127 are not yet recorded. Data of a registrant other than the master registrant is not stored. No storage of fingerprint information 122 in storage unit 120A implies a stage prior to the selling of pay television IC card 100A. This indicates that the correspondence between pay television IC card 100A and a registrant is not conducted by server device 700. Storage of fingerprint information 122 in storage unit 120A implies that pay television IC card 100A has been purchased and correspondence between that pay television IC card 100A and a registrant has already been made.

At step S104, a write preparation completion signal is output from I/F unit 191A to master registration device 800. The write preparation completion signal is received at I/F unit 291 of master registration device 800 (step S122). In response to reception of a write preparation completion signal, master registration device 800 outputs a registration preparation completion signal to server device 700A from network information input/output unit 845 via communication network 911 (step S123).

The registration preparation completion signal is received at network information input/output unit 735 of server device 700A (step S141). Server device 700A attains a standby state until the registration preparation completion signal is received (NO at step S141). Upon reception of a registration preparation completion signal (YES at step S141), a signal requesting transmission of the server ID and the server password is output to master registration device 800 (step S142).

The output server ID and server password transmission request signal is received at network information input/output unit 845 at master registration device 800 (step S124). The received server ID and server password transmission request signal is output to control unit 801. Control unit 801 provides the server ID and server password transmission request signal to pay television IC card 100A from I/F unit 291 (step S125).

The output server ID and server password transmission request signal is received at I/F unit 191A (step S105). The received server ID and server password transmission request signal is output to control unit 110. Control unit 110 reads out server ID 128 and server password 129 stored in storage unit 120A, and outputs the read out server ID 128 and server password 129 to master registration device 800 from I/F unit 191A (step S106).

The output server ID 128 and server password 129 are received at I/F unit 291 (step S126). The received server ID 128 and server password 129 are output to control unit 801. Control unit 801 dispatches server ID 128 and server password 129 from network information input/output unit 845 to server device 700A (step S127).

The output server ID 128 and server password 129 are received at network information input/output unit 735 (step S143), and provided to control unit 730. Control unit 730 reads out server ID 721 and server password 722 stored in connection permit information storage unit 720 for comparison with the received server ID 128 and server password 129 (step S144). This collocation is conducted at server ID comparison unit 762 of comparison unit 760 and server password unit 764.

When at least either the server ID or server password indicates a mismatch as a result of collocation, control unit 730 outputs an error signal from network information input/output unit 735 to master registration device 800 (step S159), and the operation of server device 700 ends (step S158). The output error signal is received at network information input/output unit 845 (step S139), and provided to control unit 801. Control unit 801 receiving the error signal issues an instruction to display server error through status notification unit 802. An error signal is output from I/F unit 291 to pay television IC card 100A (step S138). Then, the process ends (step S137).

The output error signal is received at I/F unit 191A (step S112) and provided to control unit 110. In response, control unit 110 terminates the process (step S111).

When both the server ID and server passwords match at step S144, (YES at step S144), control unit 730 and user data administration unit 710 both attain an active state via a bus 750. At the same time, a service number transmission request signal is dispatched to master registration device 800 from network information input/output unit 735 (step S145).

The service number transmission request signal is received at network information input/output unit 845 of master registration device 800 via communication network 911 (step S128), and provided to control unit 801. Control unit 801 outputs the service number transmission request signal to pay television IC card 100A from I/F unit 291 (step S129).

The output service number transmission request signal is received at I/F unit 191A (step S107), and provided to control unit 110. In response, control unit 110 provides the service number prestored in storage unit 120A to master registration device 800 from I/F unit 191A (step S108).

The output service number is received at I/F unit 291 (step S130), and provided to control unit 801. Control unit 801 dispatches the input service number to server device 700A from network information input/output unit 845 (step S131).

The dispatched service number is received at network information input/output unit 735 via communication network 911 (step S146), and output to control unit 730. Control unit 730 reads out service number 712 stored in user data administration unit 710 (step S147), and compares the read out number with the service number received at step S136 (step S148). This comparison is conducted at service number comparison unit 761 of comparison unit 760.

When the service numbers do not match as a result of comparison by service number comparison unit 761, the count n of the remaining service numbers stored in user data administration unit 710 (remaining number count of service numbers) is calculated (step S149) in order to read out the next service number. At step S150, determination is made whether the calculated remaining count n is “0” or not. When n is “0”, control proceeds to step S159, otherwise, to step S147 to read out the next service number. The comparison process of step S148 is executed for all the service numbers stored in user data administration unit 710 until a service number that matches the service number received at step S146 is read out in the process of step S147 to step S150.

When the service numbers match as a result of comparison at step S148, control unit 730 attains an active state that allows access via bus 750 to only the user data corresponding to the matching service number among the user data stored in user data administration unit 710. Simultaneously, control unit 730 dispatches an input admission signal to master registration device 800 from network information input/output unit 735 (step S151).

Matching of the service number means that the service number of the user data matches the service number stored in storage unit 120A of pay television IC card 100A. Therefore, correspondence is set between pay television IC card 100A and the user data including the service number that matches the service number stored in storage unit 120A of that pay television IC card 100A. For the sake of simplification, it is assumed that the service number stored in storage unit 120A of pay television IC card 100A is “MT0014”. On this occasion, user data 711D with the service number of “MT0014” corresponds to pay television IC card 100A. At this stage, fingerprint information 713, date of birth information 714, address information 715 and name information 716 of user data 711D has no description set therein, as shown in FIG. 18.

The dispatched input admission signal is received at network information input/output unit 845 (step S132), and output to control unit 801. Control unit 801 instructs status notification unit 802 to display a message such as “Please enter address, name, date of birth and fingerprint” (step S133).

The dealer of pay television IC card 100A responds to the displayed message through status notification unit 802 to enter the address, name, and date of birth through registrant information input unit 810 based on an ID or the like submitted by the purchaser of pay television IC card 100A. Accordingly, the address, name and date of birth are applied to registrant information input unit 810 (step S134), whereby the address information, name information, and date of birth information are output to control unit 801.

Then, the fingerprint of the purchaser is taken through fingerprint reader 250. Thus, the fingerprint of the purchaser is read by fingerprint reader 250 (step S135). The read fingerprint information is output to control unit 801.

Control unit 801 transmits the address information, name information, date of birth information, and fingerprint information to server device 700A and pay television IC card 100A (step S136). To server device 700A, control unit 801 transmits the address information, name information, date of birth information and fingerprint information from network information input/output unit 845. The output address information, name information, date of birth information and fingerprint information are received at network information input/output unit 735 of server device 700A. To pay television IC card 100A, control unit 801 provides the address information, name information and date of birth information from I/F unit 291, and the fingerprint information from fingerprint information output unit 231.

The process on the part of pay television IC card 100A will be described first. The fingerprint information output from master registration device 800 is applied to fingerprint information input unit 132 of pay television IC card 100A (step S109), and output to control unit 110. The address information, name information and date of birth information output from master registration device 800 are applied to I/F 191A of pay television IC card 100A (step S109), and provided to control unit 110.

Control unit 110 stores the input address information, name information, date of birth information and fingerprint information in the regions of address information 126, name information 127, date of birth information 123 and fingerprint information 122 in storage unit 120A (step S110). The recorded information here is the data of the master registrant. Therefore, the address information, name information, date of birth information and fingerprint information are stored in correspondence with a predefined service number required to identify pay television IC card 100A.

Following the above-described registration, a record completion signal from pay television IC card 100A is output to I/F unit 291 of master registration device 800 from I/F unit 191. Then, the process ends (step S111).

The process on the part of server device 700A will be described here. The address information, name information, date of birth information and fingerprint information output from master registration device 800 are received at network information input/output unit 735 of server device 700A (step S152), and output to control unit 730.

Control unit 730 temporarily stores the input address information, name information, date of birth information and fingerprint information in temporary storage unit 740. Then, control unit 730 reads out name information 716 of the user data stored in user data administration unit 710 to compare with the name information temporarily stored in temporary storage unit 740 (step S153). This comparison is executed at name information comparison unit 765 of comparison unit 760. Control unit 730 reads out the name information 716 of the user data stored in user data administration unit 710 for comparison with the name information temporarily stored in temporary storage unit 740 (step S153). This comparison is executed at name information comparison unit 765 of comparison unit 760, and performed for all user data 711A, 711B and 711C stored in user data administration unit 710. When there is at least one matching name information as a result of comparison, control unit 730 stores the entire user data with the matching name information in temporary storage unit 740.

Control unit 730 compares the date of birth information of the user data with the matching name information stored in temporary storage unit 740 with the date of birth information in temporary storage unit 740 received at step S152. This comparison is executed by date of birth information comparison unit 768 of comparison unit 760 with respect to all user data with the matching name information. In the case where there is at least one date of birth information that matches as a result of comparison, control unit 730 stores the entire user data with the matching name information and date of birth information in temporary storage unit 740.

Control unit 730 compares the address information of the user data with the matching name information and date of birth information stored in temporary storage unit 740 with the address information in temporary storage unit 740 received at step S152. This comparison is executed at address information comparison unit 767 of comparison unit 760 for all user data having the same name information and date of birth information. When there is at least one address information that matches as a result of comparison, control unit 730 stores the entire user data with the matching date of birth information and address information in temporary storage unit 740.

Control unit 730 also compares the fingerprint information of the user with the matching name information, date of birth information and address information stored in temporary storage unit 740 with the fingerprint information in temporary storage unit 740 received at step S152. This comparison is executed at fingerprint information comparison unit 766 of comparison unit 760 for all user data having the same name information, date of birth information and address information. When there is fingerprint information that matches as a result of comparison, control unit 730 stores the user data with the matching name information, date of birth information, address information and fingerprint information in temporary storage unit 740.

When user data having the matching name information, date of birth information, address information and fingerprint information is stored in temporary storage unit 740 (YES at step S153), the usage admitted count of the user data stored in temporary storage unit 740 is extracted (step S154). For the sake of simplification, it is assumed that the user data with the matching name information, date of birth information, address information and fingerprint information is user data 711A. It is also assumed that the usage admitted count in user data 711A is “150”.

The comparison process of the name, date of birth, address, and fingerprint at step S153 is performed to determine whether user data of the purchaser of pay television IC card 100A is present as the user data corresponding to a previously purchased pay television IC card 100A of the same person. Although comparison of at least the fingerprint information may be suffice to determine the same person, comparison of the name information, date of birth information and address information is conducted prior to fingerprint comparison in order to improve the effectiveness and accuracy of the comparison process. Therefore, only comparison of the fingerprint information may be carried out. Alternatively, a combination of fingerprint information comparison and at least the comparison of name information, date of birth information and address information may be conducted.

Then, the usage admitted count “200” in user data 711D identified as matching the service number of pay television IC card 100A at step S148 is updated, i.e. added with the usage admitted count of “150” extracted at step S154, and the updated value is recorded (step S155). Thus, the usage admitted count in user data 711D is updated to “350”. In addition to the update of user data 711D, user data 711A is deleted from user data administration unit 710 to nullify user data 711A.

Then, the date of birth information, address information, name information and fingerprint information temporarily stored in temporary storage unit 740 received at step S152 are stored at respective regions of date of birth information 714, address information 715, name information 716 and fingerprint information 713 in user data 711D that is identified as having a service number matching the service number of pay television IC card 100A at step S148 (step S156).

Control unit 730 outputs a server side storage completion signal from network information input/output unit 735 to master registration device 800 (step S157). Control unit 730 and user data administration unit 710 attain an inactive state (step S158).

The output server side storage completion signal is received at network information input/output unit 845 of master registration device 800 to be output to control unit 801. Upon receiving the server side storage completion signal from server device 700A, control unit 801 outputs an operation completion signal from I/F unit 291 to pay television IC card 100A, and terminates the access to server device 700 (step S137).

The output operation completion signal is received at I/F unit 191 of pay television IC card 100A, and output to control unit 110. In response, control unit 110 renders the set up completion signal to a signal indicating an inactive state, and ends the process (step S111).

(2) Process During Usage of Pay Television IC Card 100A

The process in the usage of pay television IC card 100A executed at the pay television system of the third embodiment will be described here.

In order to use pay television IC card 100A, the user must purchase a pay television IC card 100A, and purchase or rent descramble module 200A. The description here is based on the case of using pay television IC card 100A purchased by the process described with reference to FIGS. 20A and 20B.

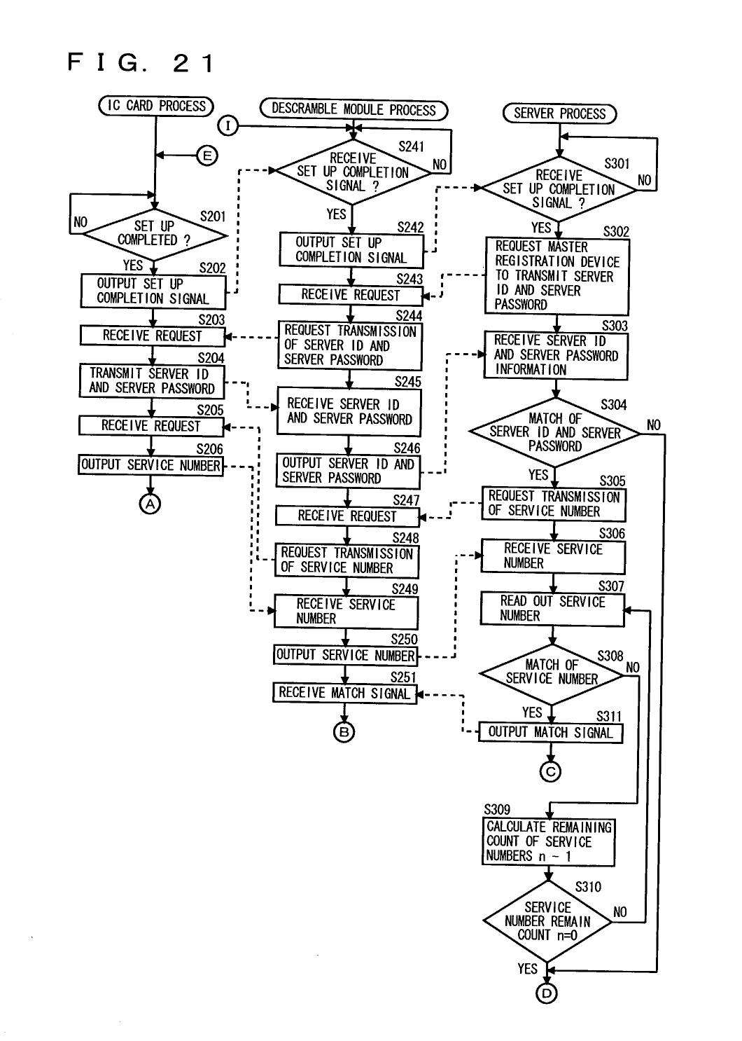

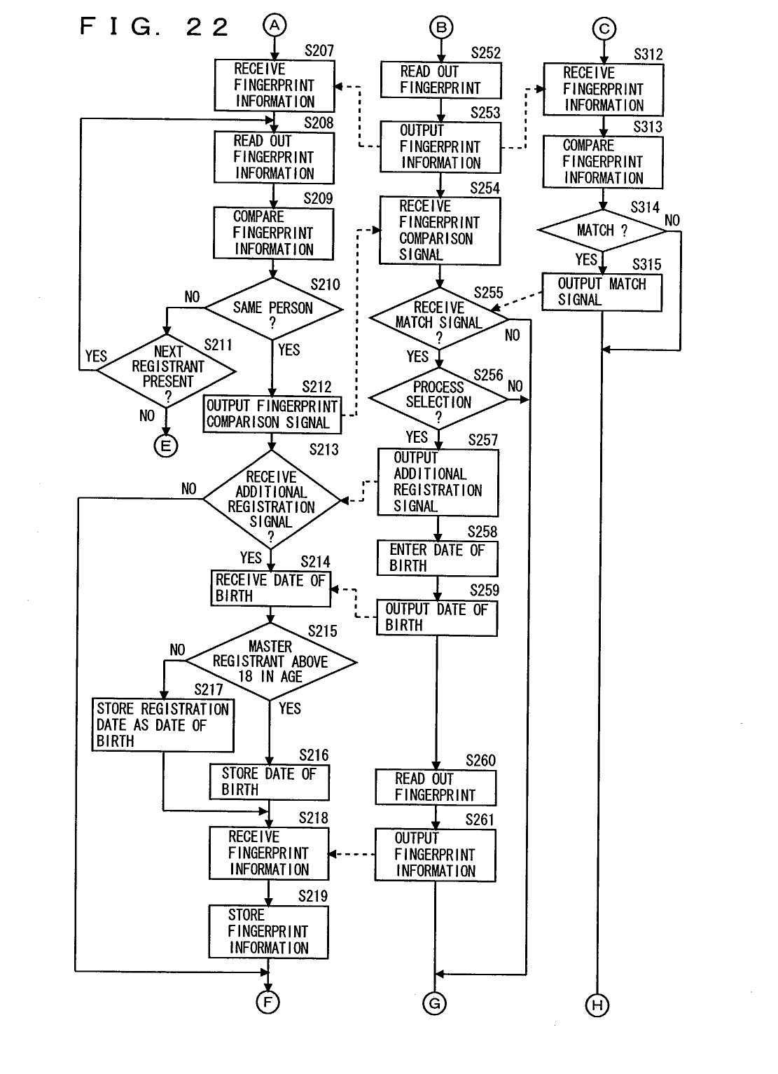

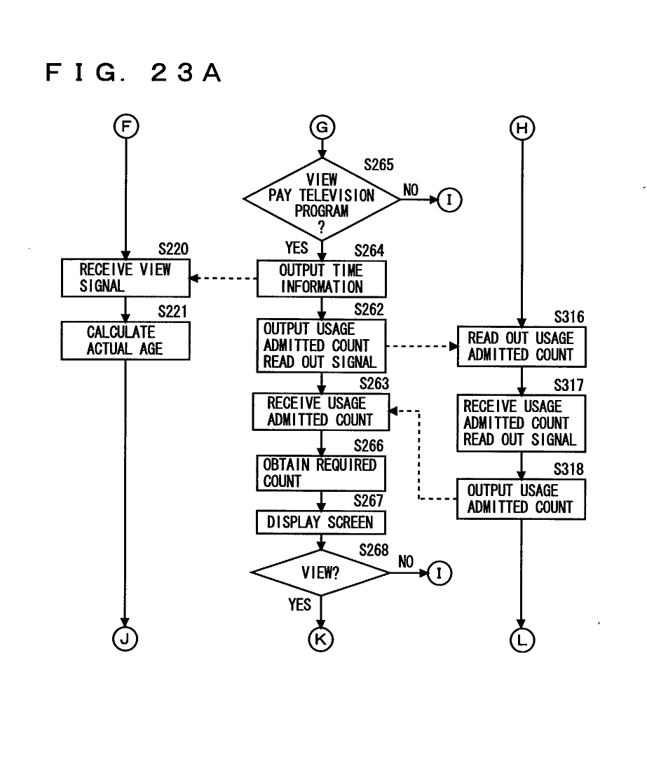

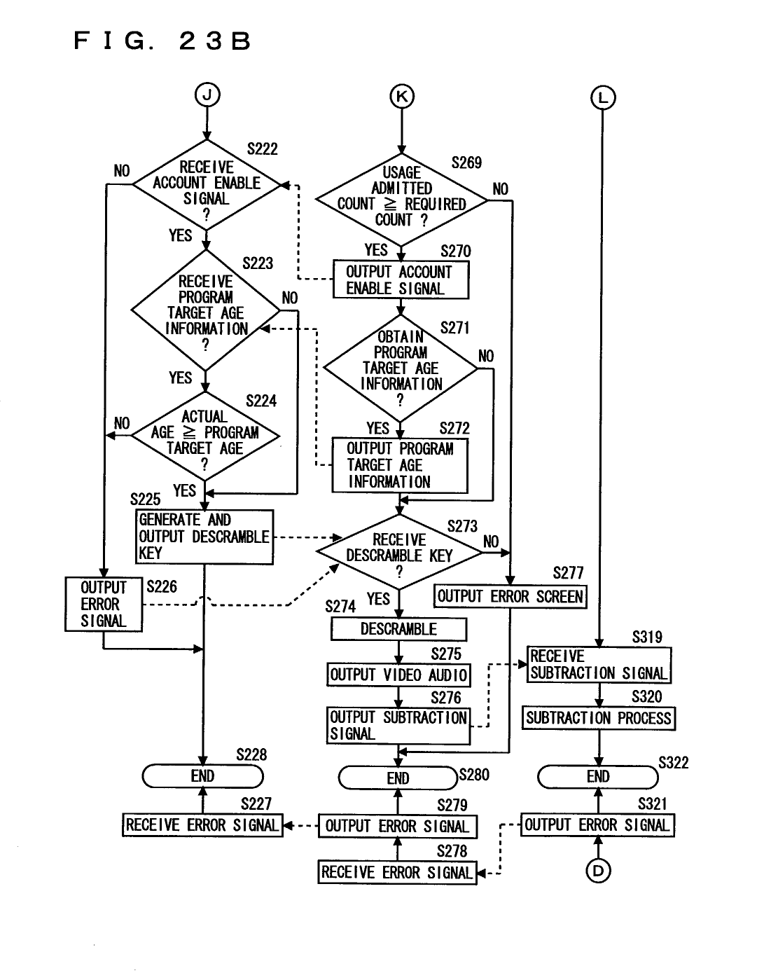

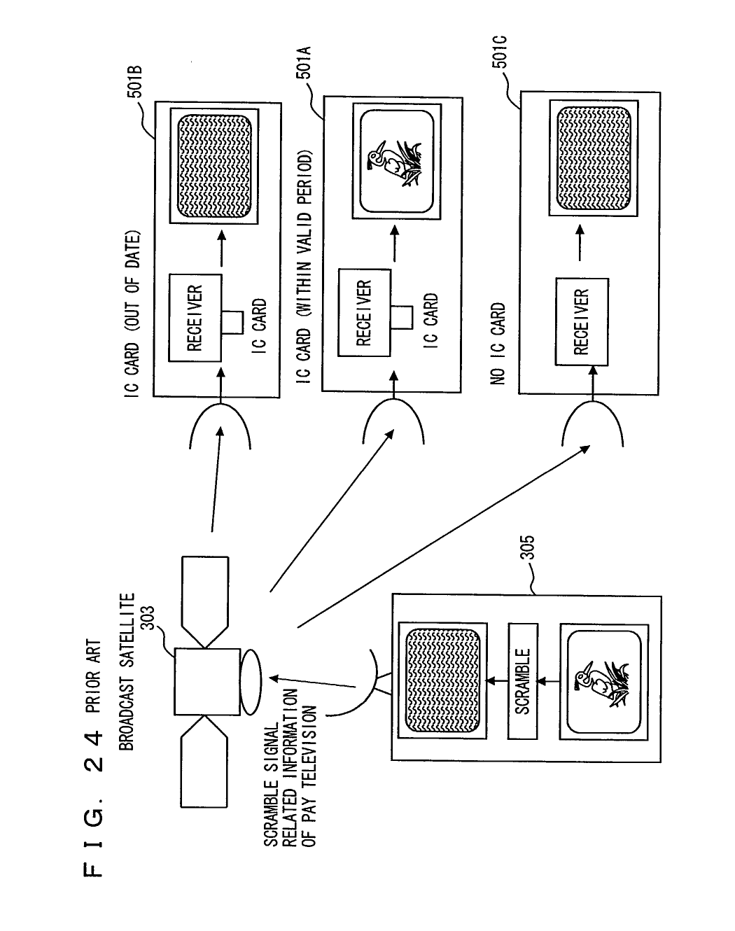

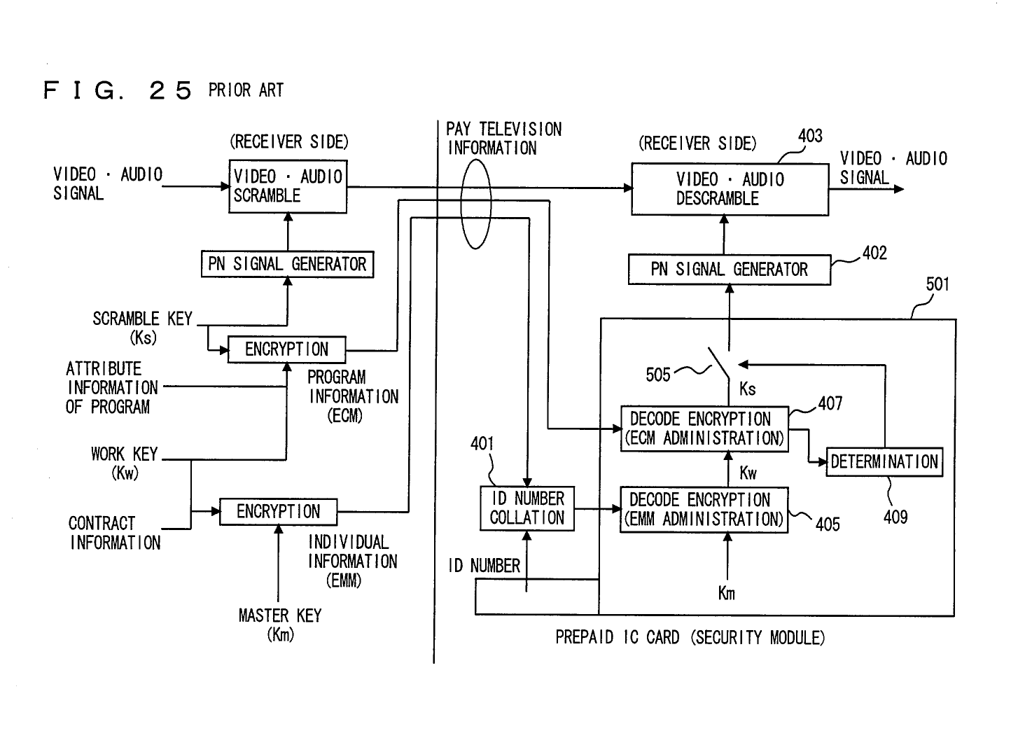

FIGS. 21, 22, 23A, and 23B are flow charts of the process executed in using a pay television IC card 100A in the pay television system of the third embodiment. FIGS. 21, 22, 23A, and 23B correspond to the process executed at pay television IC card 100A, descramble module 200A and server device 700A, respectively. The dotted lines in the drawings indicate the flow of data.

First, the user connects the obtained descramble module 200A to television set 300. Detachable pay television IC card 100A is inserted into descramble module 200A, whereby power is supplied from descramble module 200A. Connection between pay television IC card 100A and descramble module 200A may be established by the non-contact or contact type connection method.

Pay television IC card 100A supplied with power initiates the power on and reset operation under control of control unit 110. Control unit 110 determines whether the set up operation has been completed or not (step S201). This determination is based on whether the power on and reset operation has been completed. When set up is completed, a set up completion signal is output to descramble module 200A from set up completion signal output unit 190 (step 202).

When pay television IC card 100A does not attain a set up state, a signal indicating an inactive state is output from set up completion signal output unit 190. In an inactive state, data input unit 130A in pay television IC card 100A and data output unit 230A in descramble module 200A are both inactive. This means that control unit 110 does not accept an input signal even when applied. Also, information is not output from data output unit 230A.

The set up completion signal output from set up completion signal output unit 190 indicating an active state is received at set up completion signal input unit 290 of descramble module 200A (step S241). In response, data input unit 130A of pay television IC card 100A and data output unit 230A of descramble module 200A are rendered active, whereby information can be transferred between pay television IC card 100A and descramble module 200A.

Following reception of a set up completion signal at descramble module 200A (YES at step S241), the set up completion signal is output to server device 700A from network information input/output unit 245 (step S242).

The output set up completion signal is received at network information input/output unit 735 of server device 700A (step S301). Server device 700A attains a standby state until a set up completion signal is received (NO at step S301). Upon receiving a set up completion signal (YES at step S301), a user ID and server password transmission request signal is dispatched to descramble module 200A (step S302).

The output server ID and server password transmission request signal is received at network information input/output unit 245 of descramble module 200A (step S243), and output to control unit 210. Control unit 210 provides the server ID and server password transmission request signal to pay television IC card 100A from I/F unit 291 (step S244).

The output server ID and server password transmission request signal is received at I/F unit 191A (step S203), and provided to control unit 110. Control unit 110 reads out server ID 128 and server password 129 stored in storage unit 120A, and passes the read out information to descramble module 200A from I/F unit 191A (step S204).

The output server ID 128 and server password 129 are received at I/F unit 291 (step S245), and provided to control unit 210. Control unit 210 dispatches server ID 128 and server password 129 from network information input/output unit 245 to server device 700A (step S246).

The dispatched server ID 128 and server password 129 are received at network information input/output unit 735 (step S303), and provided to control unit 730. Control unit 730 reads out server ID 721 and server password 722 stored in connection permit information storage unit 720 for collation with the received server ID 128 and server password 129 (step S304). The collocation is conducted at server ID comparison unit 762 and server password comparison unit 764 of comparison unit 760.

In the case where at least either the server ID or server password does not match as a result of collocation, control unit 730 outputs an error signal from network information input/output unit 735 to descramble module 200A (step S321). The operation on the part of server device 700A ends (step S322). The output error signal is received at network information input/output unit 245 (step S278), and provided to control unit 210. In response, control unit 210 sends a command so as to display server error at television set 300 via video audio signal output unit 280. An error signal is dispatched from I/F unit 291 to pay television IC card 100A (step S279), and the process ends (step S280).

The error signal is received at I/F unit 191A (step S227), and provided to control unit 110. Control unit 110 ends the process when an error signal is received (step S228).

When determination is made of the match of the server ID and server password at step S304 (YES at step S304), control unit 730 and user data administration unit 710 both attain an active state via bus 750. Simultaneously, a service number transmission request signal is output to descramble module 200A from network information input/output unit 735 (step S305).

The service number transmission request signal is received at network information input/output unit 245 of descramble module 200A (step S247), and provided to control unit 210. Control unit 210 provides the service number transmission request signal to pay television IC card 100A from I/F unit 291 (step S248).

The output service number transmission request signal is received at I/F unit 191A (step S205), and provided to control unit 110. In response, control unit 110 outputs the service number prestored in storage unit 120A to descramble module 200A from I/F unit 191A (step S206).

The service number output here is the service number of the master registrant. The service number of the master registrant also serves as a service number to identify pay television IC card 100A.

The output service number is received at I/F unit 291 (step S249), and provided to control unit 210. Control unit 210 dispatches the input service number from network information input/output unit 245 to server device 700A (step S250).

The output service number is received at network information input/output unit 735 (step S306), and provided to control unit 730. Control unit 730 temporarily stores the input service number in temporary storage unit 740. Then, service number 712 stored in user data administration unit 710 is read out (step S307), and compared with the service numbers received at step S306 (step S308). This comparison is carried out at service number comparison unit 761 of comparison unit 760.

When the service numbers do not match as a result of comparison by service number comparison unit 760, control proceeds to step S309 to calculate the remaining count of the service numbers stored in user data administration unit 710 in order to read out the next service number (remaining count of service number). At step S310, determination is made whether the calculated remaining number count n is “0” or not. When the remaining count n is “0”, control proceeds to step S321, otherwise, to step S307 to read out the next service number. The comparison process of step S308 is executed for all the service numbers stored in user data administration unit 710 until a service number matching the service numbers received at step S306 is read out during the process from step S307 to step S310.

When the service numbers match as a result of comparison at step S308, control unit 730 attains an active state allowing access to only the user data that has a matching service number among the user data stored in user data administration unit 710 via bus 750. At the same time, control unit 730 outputs a match signal from network information input/output unit 735 to descramble module 200A (step S311).

A matching case of the service number corresponds to the case where the service number of the user data matches the service number stored in storage unit 120A of pay television IC card 100A. Therefore, correspondence is established between pay television IC card 100A and the user data with a service number that matches the service number stored in storage unit 120A of pay television IC card 100A. For the sake of simplification, it is assumed that the user data shown in FIG. 18 is stored in user data administration unit 710, and the service number stored in storage unit 120A of pay television IC card 100A is “MT0011”. In this case, user data 711A with the service number of “MT0011” corresponds to pay television IC card 100A.

The output match signal is received at network information input/output unit 245 (step S251), and provided to control unit 210. Control unit 210 sends out a command so as to provide a message such as “Please enter fingerprint” at television set 300 via video audio signal output unit 280. Then, fingerprint reader 250 and fingerprint information output unit 231 are rendered active (step S252).

The user of pay television IC card 100A can have his/her fingerprint taken through fingerprint reader 250 in descramble module 200A. The fingerprint of the user read by fingerprint reader 250 is transmitted to pay television IC card 100A and server device 700A as fingerprint information (step S253). To pay television IC card 100A, the fingerprint information is output from fingerprint information output unit 231 of data output unit 230A to fingerprint information input unit 132 of pay television IC card 100A. To server device 700A, the fingerprint information is output from network information input/output unit 245 to network information input/output unit 735 of server device 700A.

At pay television IC card 100A, the fingerprint information is received at fingerprint information input unit 132 (step S207), and provided to control unit 110. Control unit 110 temporarily stores the input fingerprint information in fingerprint information storage unit 163 of information temporary storage 160. Then, control unit 110 stores fingerprint information 122 of the registrant prestored in storage unit 120A into registrant fingerprint information storage unit 164 (step S208). Fingerprint comparison determination unit 175 compares the fingerprint information temporarily stored in fingerprint information storage unit 163 with the fingerprint information temporarily stored in registrant fingerprint information storage unit 164 (step S209). In other words, the fingerprint information of the user of pay television IC card 100A is compared with the fingerprint information of a registrant stored in storage unit 120A.

The process in the case where the fingerprint information temporarily stored in fingerprint information storage unit 163 does not match the registrant fingerprint information temporarily stored in registrant fingerprint information storage unit 164 at step S209 will be described hereinafter (NO at step 210). For the purpose of conducting collocation of the fingerprint of all registrants registered in pay television IC card 100A, determination is made whether a next registrant is present (step S211). When there is a registrant, control proceeds to step S208. The fingerprint information of that registrant is compared with the fingerprint information temporarily stored in registrant fingerprint information storage unit 164 (step S209).

By the process from steps S208 to S211, fingerprint information 122 of all registrants prestored in storage unit 120A is compared with the fingerprint information temporarily stored in registrant fingerprint information storage unit 164.

When none of the fingerprint information of all the registrants stored in storage unit 120A match (NO at step S211), control returns to step S201. On this occasion, the set up completion signal of pay television IC card 100A is rendered inactive.

The process subsequent to step S209 in the case where the fingerprint information match will be described hereinafter.

At step S253, the fingerprint information of the user from descramble module 200A is output to server device 700A. On the part of server device 700A, the output user's fingerprint information is received at network information input/output unit 735 (step S312), and provided to control unit 730. Control unit 730 temporarily stores the user's fingerprint information in temporary storage unit 740. Fingerprint information comparison unit 766 of comparison unit 760 reads out fingerprint information 713 of user data 711A with the matching service number of “MT0011” identified at step S308 for comparison with the user's fingerprint information in temporary storage unit 740 (step S313).

When the fingerprint information match as a result of comparison (YES at step S314), determination is made that the user of pay television IC card 100A is the master registrant. A match signal is dispatched from network information input/output unit 735 to descramble module 200A.

The output match signal is received at network information input/output unit 245 (step S255), and provided to control unit 210. When a match signal is received, control proceeds to step S256, otherwise, to step S262.

At step S256, a command is output to provide a selection screen to display the messages of, for example, “VIEW PAY TELEVISION PROGRAM” and “REGISTRATION OF NEW USER” via video audio signal output unit 280 to television set 300. Waiting is conducted for the reception of a select signal by the user. When an additional registration process is selected, control proceeds to step S257, otherwise, to step S262.

At step S257, an additional registration signal is output to pay television IC card 100A from I/F unit 291 for the execution of an additional registration process at pay television IC card 100A (step S257). The additional registration signal is received at I/F unit 191A (step S213).

At step S258, a message of “Please enter date of birth of additional registrant” is displayed on the screen of television set 300 via video audio signal output unit 280. The additional registrant enters his/her date of birth through the numeric input unit of television set 300. The input date of birth of the additional registrant is supplied to control unit 210 via receiver I/F unit 281 (step S258). The date of birth information of the additional subscriber supplied to control unit 210 is output from I/F unit 291 to pay television IC card 100A (step S259).

Then, a message such as “Please enter fingerprint of the additional registrant” is displayed on the screen of television set 300 via video audio signal output unit 280. Fingerprint reader 250 and fingerprint information output unit 231 are rendered active (step S260). The fingerprint information of the person who is to be additionally registered, read by fingerprint reader 250, is output from fingerprint information output unit 231 to pay television IC card 100A (step S261).

When the additional registration signal is received at I/F unit 191A from descramble module 200A at pay television IC card 100A (step S213), control proceeds to step S214. When the additional registration signal is not received, control proceeds to step S220.

In response to reception of the additional registration signal, storage unit 120A is rendered to a registration enable state of the user. Also, a service number for the additional registrant is automatically assigned (step S213). This service number is a number differing from the service number of the master registrant. As shown in FIG. 16, the service numbers of “AT0011, “AT0012 and “AT0013” are assigned with respect to the master registrant service number “MT0011”.

At step S214, the date of birth information of the additional registrant is received at I/F unit 191A (step S214). At step S215, control unit 110 determines whether the master registrant actual age information 124 stored in storage unit 120A is over the age of 18. When older than 18, control proceeds to step S216, otherwise, to step S217.

The actual age information of the master registrant is prestored in storage unit 120A of pay television IC card 100A. The actual age information of the master registrant is stored in storage unit 120A from the calculation based on date of birth information 123 of the master registrant and the time information received from descramble module 200A. The time information received from descramble module 200A is counted by timer 235, and output from time information output unit 236. Time information is received at time information input unit 131 of pay television IC card 100A.

At step S216, the date of birth information of the additional registrant received at I/F unit 191A at step S214 is stored into storage unit 120A. Here, the date of birth information of the additional registrant is stored as the user data of the newly assigned service number newly assigned at step S213.

At step S217, the date of registration (the current date) is stored in the date of birth information in the user data corresponding to the newly assigned service number at step S213 among the user data in storage unit 120A. This information is required to register a registrant that is below the age of 18 to disable improper viewing of an age-limited pay television program.

At step S218, fingerprint information output from descramble module 200A is received at fingerprint information input unit 132 (step S218). The received fingerprint information is stored as the fingerprint information of the user data corresponding to the newly assigned service number (step S219).

Although not shown, the presence of an additional registrant is confirmed every time an additional registration process ends. Confirmation is made whether to continue an additional registration process or not. Additional registration can be carried out without the need of the fingerprint verification of the master registrant only in the case where additional information is continued.

When “VIEW PAY TELEVISION PROGRAM” is selected at step S256, descramble module 200A dispatches a usage admitted count read out signal from network information input/output unit 245 to server device 700A (step S262).

The output usage admitted count read out signal is received at network information input/output unit 735 (step S316), and provided to control unit 730. Control unit 730 reads out usage admitted count 717 of user data 711A identified as having a matching service number at step S308 (step S317), and temporarily stores count 717 in temporary storage unit 740. Assuming that the service number received at step S306 is “MT0011”, the user data identified as having a matching service number at step S308 is user data 711A. The usable admitted count thereof is “150”.

Control unit 730 outputs a usable admitted count to descramble module 200A from network information input/output unit 735 (step S318). The output usage admitted count is received at network information input/output unit 245 (step S263), and provided to control unit 210. Control unit 210 temporarily stores the usage admitted count in temporary storage unit 215.

At step S264, the time information counted by timer 235 is output to pay television IC card 100A from time information output unit 236.

The output time information is received at time information input unit 131 of pay television IC card 100A (step S220), and provided to control unit 110. At control unit 110, the actual age is calculated based on the received time information and the date of birth information 123 of the user stored in storage unit 120A (step S221). The calculated actual age is stored in actual age information storage unit 162 of storage unit 120A.

On the part of descramble module 200A, a screen including the usage admitted count and a message to select “VIEW PAY TELEVISION PROGRAM” is displayed at television set 300 via video audio signal output unit 280 to accept a selection entry (step S265). When “VIEW PAY TELEVISION PROGRAM” is selected, control proceeds to step S266. When “NOT VIEW PAY TELEVISION PROGRAM”, control returns to step S241.

Encrypted required count signal 205 is supplied from broadcast station 900 to broadcast information input unit 240A of descramble module 200A. Broadcast information input unit 240A outputs encrypted required count signal 205 to required count information decoder 275. Required count information decoder 275 decodes encrypted required count signal 205 and supplies the decoded required count to control unit 210 (step S266). The required count is a signal input to broadcast information input unit 240A for each pay television program, indicating the count required to view that pay television program.

Control unit 210 causes the decoded required count at television set 300 via video audio signal output unit 280 (step S267). At this time point, the usage admitted count corresponding to pay television IC card 100A, and the required count in order to view the pay television program are displayed on the screen of television set 300.

When the user selects “VIEW PAY TELEVISION PROGRAM” (YES at step S268), control unit 210 compares the usage admitted count signal stored in temporary storage unit 215 with the decoded required count signal (step S269). When the usage admitted count signal indicates a value equal to or above the value of the decoded required count signal (YES at step S269), control proceeds to step S270, otherwise, to step S277. At step S270, control unit 210 outputs an account enable signal from account enable signal output unit 237 of data output unit 230A to pay television IC card 100A (step S270).

The account enable signal is received at account enable signal input unit 134 (step S222), and provided to control unit 110. When the account enable signal is received, control proceeds to step S223, otherwise, to step S226.

Program attribute signal decoder 270 decodes encrypted program attribute signal 203, and provides program target age information to control unit 210. At this stage, control unit 210 determines the presence/absence of program target age information (step S271). When program target age information is present, control unit 210 outputs the input program target age information to pay television IC card 100A from program target age information output unit 232 (step S272). When program target age information is not present, control proceeds to step S273.

The output program target age information is received at program target age information input unit 133 (step S223), and provided to control unit 110. The program target age information, when received, is temporarily stored in program target age information storage unit 161, and control proceeds to step S224. When program target age information is not received, control proceeds to step S225.

At step S224, age comparison unit 171 compares the actual age information 124 stored in actual age information storage unit 162 at step S221 with the program target age information stored in program target age information storage unit 161. When the actual age information 124 is equal to or over the value in the program target age information, control proceeds to step S225, otherwise, to step S226.

At step S255, a descramble key is generated at descramble key generation unit 140, and output to descramble key input unit 260 of descramble module 200A. At step S226, the error signal is output to descramble module 200A.

When program target age information is included in the program attribute signal, the two conditions, i.e., reception of an account enable signal at step S222 and determination of the actual age being above the program target age at step S224, are established, whereby a descramble key is generated at descramble key generation unit 140. When program target age information is not included in the program attribute signal, the condition of reception of an account enable signal at step S222 is established, whereby a descramble key is generated at descramble key generation unit 140.

At descramble module 200A, determination is made whether a descramble key has been received from pay television IC card 100A (step S273). When a descramble key has been received, control proceeds to step S274. When an error key has been received, control proceeds to step S277.

At step S274, a descramble process on video audio scramble signal 201 is conducted based on the received descramble key at descramble unit 220. A descrambled signal 202 is output to television set 300 via video audio signal output unit 280 (step S275).

Then, control unit 210 outputs the required count temporarily stored in temporary storage unit 215 to server device 700A (step S276). The output required count is received at network information input/output unit 735 (step S319), and provided to control unit 730. Control unit 730 reads out usage admitted count 717 of user data 711A identified as having a service number matching the service number of pay television IC card 100A at step S308, and updates the usage admitted count to a value that has the required count subtracted (step S320). For example, in the case where the required count is “5”, the usage admitted count “150” of user data 711A corresponding to the service number of “MT0011” shown in FIG. 18 is updated to “145”.

When the user selects “NOT VIEW PAY TELEVISION” at step S265 or step S268, descramble module 200A and server device 700A cancel the access therebetween, and respectively return to the initial screen. On this occasion, the set up completion signal of a pay television IC card 100A is rendered inactive.

At step S277, a message such as “LACK OF USAGE ADMITTED COUNT” is displayed when the usage admitted count is below the required count at step S269, and a message such as “PROGRAM IS AGE LIMITED” is displayed when an error signal is received at step S273 on television set 300. Then, descramble module 200A and server device 700A cancel the access therebetween, and return to respective initial screens. At this stage, the set up completion signal of pay television IC card 100A is rendered inactive.

In pay television system 910 of the third embodiment, the usage admitted count of pay television IC card 100A is administered at server device 700A, and a fingerprint is employed for verification of the user. Therefore, security of a high level can be ensured. Even in the case where pay television IC card 100A is lost and passed to the hands of a third party, usage of pay television IC card 100A by a stranger is inhibited.

Furthermore, since an age-limited pay television program cannot be played on a television set when the age of the user is not over the specified age, the audience of an age-restricted program can be limited. In other words, certain persons such as a person under age is inhibited of viewing.

Since the usage admitted count of pay television IC card 100A is administered at server device 700A, a user purchasing a new pay television IC card 100A can have the remaining admitted usage count in the previous owned pay television IC card 100A added to the value of the usage count of the new pay television IC card 100A. Since it is only required for the user to own a newly purchased pay television IC card 100A, the ownership and administration of the pay television IC card 100A can be simplified.

The present invention is also advantageous in a case where the user loses his/her pay television IC card 100A. The user will be allowed to use the previously obtained usage admitted count by having a pay television IC card 100A issued again.

It is to be noted that an extra process to disable the lost pay television IC card 100A is not required. The load on the pay television service provider that issues a pay television IC card 100A can be alleviated.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An IC card comprising:
a physical description data storage unit prestoring physical description data that allows identification of a predetermined person,
a physical description data acceptance unit accepting input of physical description data of a user,
a determination unit comparing physical description data accepted by said physical description data acceptance unit with physical description data stored in said physical description data storage unit to determine whether said user is said predetermined person, and
an output unit providing an admission signal based on a determination result by said determination unit.

2. The IC card according to claim 1, wherein said physical description data includes image data obtained by picking up an image of a fingerprint.

3. The IC card according to claim 1, wherein said physical description data storage unit stores physical description data of a plurality of persons.

4. The IC card according to claim 1, wherein said admission signal output from said output unit is a signal to cancel scramble of scramble-processed information.

5. The IC card according to claim 1, wherein said determination unit determines that said user is said predetermined person when physical description data accepted at said physical description data acceptance unit matches or is similar to physical description data stored in said physical description data storage unit.

6. The IC card according to claim 1, further comprising:
an age information acquirement unit acquiring age information of said predetermined person,
a reception unit receiving program target age information included in a program signal, and
an age comparison unit comparing age information acquired by said age information acquirement unit with program target age information received at said reception unit,
wherein said output unit outputs a signal to cancel scramble of scramble-processed broadcast information based on a comparison result of said age comparison unit in addition to a determination result by said determination unit.

7. The IC card according to claim 6, further comprising:
a date of birth data storage unit prestoring the date of birth of said predetermined person, and
a date data acceptance unit accepting input of data related to the current date,
wherein said age information acquirement unit acquires said age information based on the date of birth data stored in said date of birth data storage unit and date data accepted by said date data acceptance unit.

8. The IC card according to claim 6, wherein said output unit provides a signal to cancel scramble of scramble-processed broadcast information when said age comparison unit determines that age information acquired by said age acquirement unit is at least the age in said age information received at said reception unit.

9. A method of determining an authorized person comprising the steps of:
prestoring physical description data that allows identification of a predetermined person,
accepting input of physical description data of a user,
comparing physical description data accepted at said physical description data acceptance step with said prestored physical description data to determine whether said user is said predetermined person, and
providing an admission signal based on a determination result of said determination step.

10. The method of determining an authorized person according to claim 9, wherein said admission signal provided at said output step is a signal to cancel scramble of scramble-processed information.

11. A program of determining an authorized person causing a computer to execute the steps of:
prestoring physical description data that allows identification of a predetermined person,
accepting input of physical description data of a user,
comparing physical description data accepted at said physical description data acceptance step with said prestored physical description data to determine whether said user is said predetermined person, and
providing an admission signal based on a determination result of said determination step.

12. The program of determining an authorized person according to claim 11, wherein said admission signal provided at said output step is a signal to cancel scramble of scramble-processed information.

13. A computer readable recording medium recorded with the program of determining an authorized person defined in claim 11.

14. An IC card comprising:
a storage unit storing physical description data that allows identification of a predetermined person,
an acceptance unit accepting input of physical description data of a person,
a determination unit comparing said input physical description data with said stored physical description data of said predetermined person to determine whether the person corresponding to said input physical description data is said predetermined person, and
a control unit providing control so as to allow input of physical description data of another person differing from said predetermined person at said acceptance unit, and store said input physical description data of said another person in said storage unit when determination is made by said determination unit that the person corresponding to said input physical description data is said predetermined person.

15. A method of registering an authorized person comprising the steps of:
storing physical description data that allows identification of a predetermined person,
accepting input of physical description data of a person,
comparing said input physical description data with said stored physical description data of said predetermined person to determine whether the person corresponding to said input physical description data is said predetermined person,
allowing input of physical description data of another person differing from said predetermined person when determination is made at said determination step that the person corresponding to said input physical description data is said predetermined person, and
storing said input physical description data of said another person.

16. A program of registering an authorized person causing a computer to execute the steps of:
storing physical description data that allows identification of a predetermined person,
accepting input of physical description data of a person,
comparing said input physical description data with said stored physical description data of said predetermined person to determine whether the person corresponding to said input physical description data is said predetermined person,
allowing input of physical description data of another person differing from said predetermined person when determination is made at said determination step that the person corresponding to said input physical description data is said predetermined person, and
storing said input physical description data of said another person.

17. A computer readable recording medium recorded with the program of registering an authorized person defined in claim 16.

18. A descrambler comprising:
a physical description data storage unit prestoring physical description data that allows identification of a predetermined person,
a reader reading out physical description data of a user,
a determination unit comparing physical description data read out by said reader with said physical description data stored in said physical description data storage unit to determine whether said user is said predetermined person, and
a descramble unit canceling scramble of scramble-processed information based on a determination result by said determination unit.

19. A server device comprising:
a usage admitted count storage unit storing in correspondence a service number required to identify an IC card and a usage admitted count of an IC card,
a reception unit receiving physical description data and a service number required to identify a person, and
a control unit storing said received physical description data in correspondence with said received service number in said usage admitted count storage unit.

20. The server device according to claim 19, further comprising:
a determination unit determining whether physical description data of a person identical to the person corresponding to said received physical description data is already stored in said usage admitted count storage unit, and
an update unit updating the usage admitted count stored corresponding to said received service number to a value having the usage admitted count already stored corresponding to said received physical description data added, according to a determination result by said determination unit.

21. The server device according to claim 19, further comprising:
a usage count reception unit receiving a service number and a usage count, and
a subtractor subtracting said received usage count from said usage admitted count stored corresponding to said received service number, according to reception of said usage count.

22. The server device according to claim 19, wherein said usage admitted count storage unit stores data corresponding to a plurality of service numbers.

23. The server device according to claim 19, wherein said physical description data includes image data obtained by picking up an image of a fingerprint.

24. The server device according to claim 19, wherein said determination unit determines, when said received physical description data is identical or similar to physical description data stored in said usage admitted count storage unit, that the physical description data is of the same person.

25. The server device according to claim 19, further comprising:
a usage count reception unit receiving a service number and a usage count,
a determination unit determining whether the usage admitted count stored corresponding to said received service number is at least said usage count, and
a determination result output unit providing a determination result by said determination unit.

26. A method of administering a count executed by a server device including a usage admitted count storage unit storing a service number required to identify an IC card and a usage admitted count of an IC card in correspondence, comprising the steps of:
receiving physical description data and a service number required to identify a person, and
storing said received physical description data in said usage admitted count storage unit in correspondence with said received service number.

27. A count administration program executed by a server device including a usage admitted count storage unit storing a service number required to identify an IC card and a usage admitted count of an IC card in correspondence, comprising the steps of:
receiving physical description data and a service number required to identify a person, and
storing said received physical description data in said usage admitted count storage unit in correspondence with said received service number.

28. A computer readable recording medium recorded with the count administration program defined in claim 27.

29. A physical description data reader comprising:
a service number reception unit receiving from an IC card a service number required to identify said IC card,
a physical description data reader unit reading out physical description data of a user, and
a transmission unit transmitting said read physical description data and said received service number to a server device that stores a usage admitted count of said IC card.
